(19) United States
(12) Patent Application Publication
(10) Pub. No.: US 2018/0210561 A1
(43) Pub. Date: Jul. 26, 2018

(54) INPUT UNIT, INPUT METHOD, INPUT SYSTEM, AND INPUT SUPPORT SYSTEM

(71) Applicant: Semiconductor Energy Laboratory Co., Ltd., Atsugi-shi (JP)

(72) Inventors: Isamu SHIGEMORI, Atsugi (JP); Satoru OKAMOTO, Isehara (JP)

(21) Appl. No.: 15/874,452

(22) Filed: Jan. 18, 2018

(30) Foreign Application Priority Data
Jan. 24, 2017 (JP) 2017-010094

(51) Int. Cl. G06F 3/03; G06F 3/01; G06F 3/0487; G02B 27/01

(52) U.S. Cl. CPC G06F 3/0308; G06F 3/012; G02B 2027/0178; G02B 27/017; G06F 3/0487

(57) ABSTRACT

Provided is an input unit and input method for an information terminal for easy input work and avoiding an operating error. Included are a support, an input unit including a laser device on the support, an information terminal including a sensor in a display portion, and a switch connected with or without a wire to at least one of the laser device and the information terminal. A desired region of the display portion is irradiated with laser light output from the input unit. Information is input to the region by operation of the switch in the state where the region is irradiated with laser light.

### BACKGROUND OF THE INVENTION

### 1. Field of the Invention

One embodiment of the present invention relates to an information terminal, a display device, an input unit for the information terminal, and an input method, input system, and input support system for the information terminal with them.

One embodiment of the present invention is not limited to the above technical field. The technical field of the invention disclosed in this specification and the like relates to an object, a method, or a manufacturing method. One embodiment of the present invention relates to a process, a machine, manufacture, or a composition of matter.

### 2. Description of the Related Art

In recent years, with the spread of information terminals provided with a touch panel such as smartphones and tablet terminals, input to an information terminal by operation of a touch panel is becoming usual. The user of the information terminal inputs information to the information terminal with the finger or a touch pen such as a stylus.

For example, inputting information using a pen to a display device including an input portion in the display portion is known (Patent Document 1).

### REFERENCE

### Patent Document

[Patent Document 1] Japanese Published Patent Application No. 2002-287900

### SUMMARY OF THE INVENTION

However, it is difficult to perform such a touch operation on a touch panel for users who cannot freely move parts of the body (especially upper limbs, hands, and fingertips), users who have no feeling in the fingertips, and users who have deficiencies in parts of the body, suffering cervical spine injury or the like. Specifically, for cervical spine injured people, the act itself of moving the fingers is difficult in some cases, and it is difficult for them to move their fingers to desired regions of a display portion provided in an information terminal. It is also difficult for users with poor finger tactility to recognize whether they touch a display portion. In such a case, information input to an information terminal is a troublesome act for the users, and there is a possibility of an operating error or an input error on the information terminal. Also for users who have deficiencies in their upper limbs, a touch of a display portion with the hands or fingers is impossible in some cases.

In view of the above problems, an object of one embodiment of the present invention is to provide an input unit, input method, and input support system for an information terminal for easy input work and avoiding an operating error.

Note that the descriptions of these objects do not disturb the existence of other objects. In one embodiment of the present invention, there is no need to achieve all the objects. Other objects will be apparent from and can be derived from the description of the specification, the drawings, the claims, and the like.

Note that the objects of one embodiment of the present invention are not limited to the above objects. The objects described above do not disturb the existence of other objects. The other objects are the ones that are not described above and will be described below. The other objects will be apparent from and can be derived from the description of the specification, the drawings, and the like by those skilled in the art. One embodiment of the present invention is to solve at least one of the aforementioned objects and the other objects.

One embodiment of the present invention is an information terminal in which a laser light detection portion is provided in a display portion.

One embodiment of the present invention is an input unit for an information terminal whose support is provided with a laser device.

One embodiment of the present invention is an input system in which a display portion of an information terminal is irradiated with laser light and a switch connected to at least one of a laser device and the information terminal with or without a wire is operated, thereby emulating a touch.

Note that two kinds of laser light may be used for input of information to the information terminal. Here, the two kinds of laser light mean laser light with different intensities and emitted from one laser device; laser light with different output pulses and emitted from one laser device; or laser light emitted from different laser devices.

The laser device is preferably provided on a support such as glasses, a hat, or a head gear. In that case, the laser device is mounted on a user's head so that a desired position of a display portion included in the information terminal is irradiated with laser light in accordance with the movement of the user. Thus, users who cannot freely move parts of the body (especially upper limbs, hands, and fingertips), users who have no feeling in the fingertips, or users who have difficulties or deficiencies in parts of the body can select a desired position to input information.

A desired position may be selected by a first laser light and information may be input by a second laser light. In that case, a laser light detection portion that detects at least the second laser light is provided in the display portion of the information terminal.

Between the laser device and the support, a movable portion for adjusting the output direction of laser light so that the position irradiated with laser light can coincide with a user's line of sight may be provided.

The second laser light may be output by the operation of the switch.

It is preferable that the switch can be operated by users with disabled hands or finger. For example, a breath switch, a push-button switch that can be operated with hand, arm, leg, chin, or the like, a pedal switch, a switch operated by grasping a rubber ball or the like, or a blink switch can be used.

One embodiment of the present invention is an input unit for an information terminal including a support, a movable portion provided on the support, a laser device provided on the support with the movable portion provided therebetween, and a switch connected to the laser device. The movable portion for adjusting the output direction of laser light is provided so that the output direction of laser light from the laser device can coincide with a user's line of sight.

It is preferable to select the support from glasses, a hat, a helmet, and a headgear.

It is preferable to select the switch from a breath switch, a push-button switch, a pedal switch, and a blink switch.

The laser device may output a first laser light and a second laser light. The first laser light and the second laser light may be switched by the switch.

One embodiment of the present invention is an input method for an information terminal including an information terminal and an input unit for performing input to the information terminal. The input unit includes a laser device and a switch connected to the laser device. The information terminal includes a display portion. The display portion includes a sensor. A region in the display portion is irradiated with a first laser light output from the laser device. The first laser light is switched from the first laser light to a second laser light. The region is irradiated with the second laser light. The sensor included in the region detects the second laser light. The first laser light is switched to the second laser light with the switch.

It is preferable that the second laser light and the first laser light have different intensities.

The second laser light preferably has a higher intensity than the first laser light.

Each of the first laser light and the second laser light is preferably pulsed laser light.

The second laser light preferably has a shorter pulse period than the first laser light.

It is preferable that the second laser light and the first laser light have different duty ratios.

One embodiment of the present invention is an input support system for an information terminal including an information terminal, an input unit for performing input to the information terminal, and artificial intelligence. The input unit includes a laser device and a switch connected to the laser device. The information terminal includes a display portion. The display portion includes a sensor. A region in the display portion is irradiated with a first laser light output from the laser device. The sensor detects the first laser light. Information is input to the information terminal with the switch. The artificial intelligence extracts and holds a movement pattern of the first laser light detected by the sensor.

According to one embodiment of the present invention, an input unit, input method, and input support system for an information terminal for easy input work and avoiding an operating error can be provided.

The use of laser light as the input unit enables users to perform input to an information terminal or a display device apart from the users. Therefore, an information terminal of the present invention is not limited to a portable information terminal such as a smartphone or a tablet-type computer. The structure of the present invention can be used for a stationary information terminal or display device, such as a monitor of a desktop computer or a laptop computer, a television, a large-sized monitor that can be used for a conference such as a television conference and many people can watch at the same time, digital signage in public facilities, commercial facilities, or transportation. Thus, the present invention is intended for a variety of information terminals and display devices. In this specification, these objects are referred to as information terminals or information terminals including a display portion.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

FIG. 1 illustrates an input unit, an information terminal, and an application example of one embodiment of the present invention.

FIGS. 2A and 2B each illustrate an input unit of one embodiment of the present invention.

FIGS. 3A and 3B illustrate input units of one embodiment of the present invention.

FIG. 4 illustrates an input unit and an application example of one embodiment of the present invention.

FIGS. 5A and 5B are timing charts showing an example of input operation of one embodiment of the present invention.

FIGS. 6A and 6B are timing charts showing an example of input operation of one embodiment of the present invention.

FIG. 7 is a timing chart showing an example of input operation of one embodiment of the present invention.

FIGS. 8A and 8B are timing charts showing an example of input operation of one embodiment of the present invention.

FIG. 9 is a timing chart showing an example of input operation of one embodiment of the present invention.

FIG. 10 is a block diagram illustrating a configuration of an input unit and an information terminal of one embodiment of the present invention.

FIGS. 11A to 11D illustrate examples of input operation of one embodiment of the present invention.

FIGS. 12A and 12B are flow charts showing extraction of an input pattern and input support with artificial intelligence.

FIG. 13 is a block diagram showing a structure of a display panel of one embodiment of the present invention.

FIG. 14 illustrates a pixel circuit of a display panel of one embodiment of the present invention.

FIG. 15 illustrates a pixel circuit of a display panel of one embodiment of the present invention.

FIG. 16 is a timing chart showing operation of a photosensor of one embodiment of the present invention.

FIGS. 17A to 17D illustrate pixel circuits of a display panel of one embodiment of the present invention.

FIG. 18 is a cross-sectional view illustrating a display portion of one embodiment of the present invention.

FIG. 19 is a cross-sectional view illustrating a display portion of one embodiment of the present invention.

FIGS. 20A to 20C are cross-sectional views illustrating a display portion of one embodiment of the present invention.

FIGS. 21A to 21E illustrate electronic devices of one embodiment of the present invention.

FIGS. 22A and 22B each illustrate an electronic device of one embodiment of the present invention.

FIGS. 23A and 23B illustrate electronic devices of embodiments of the present invention.

### DETAILED DESCRIPTION OF THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

In the drawings, the size, the layer thickness, or the region is exaggerated for clarity in some cases. Therefore, the size, the layer thickness, or the region is not limited to the illustrated scale. Note that the drawings are schematic views showing ideal examples, and embodiments of the present invention are not limited to shapes or values shown in the drawings.

Note that in this specification, a high power supply voltage and a low power supply voltage are sometimes referred to as an H level (or VDD) and an L level (or GND), respectively.

Furthermore, in the present specification, any of the embodiments described below can be combined as appropriate. In addition, in the case where a plurality of structure examples are described in one embodiment, some of the structure examples can be combined as appropriate.

### Embodiment 1

In this embodiment, an information terminal and an input unit which are embodiments of the present invention will be described.

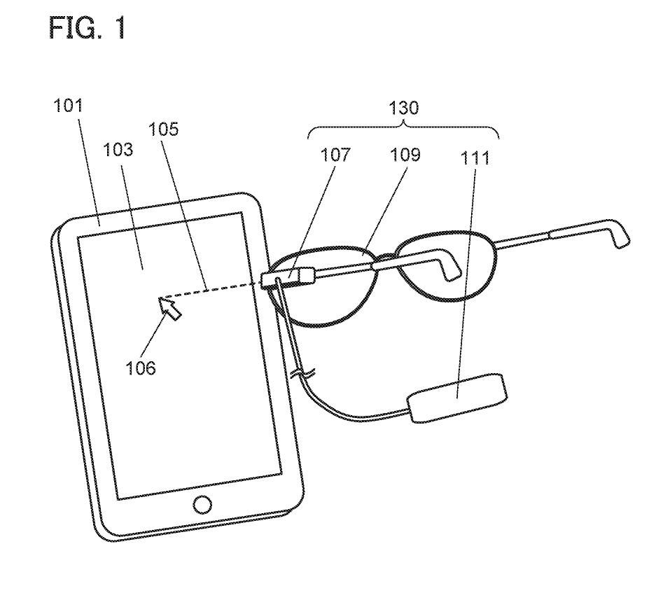

An information terminal 101 illustrated in FIG. 1 includes a display portion 103. A sensor for detecting a laser light 105 is provided in the display portion. As the sensor for detecting the laser light 105, a photosensor or a photodiode can be used. The sensor can preferably detect the intensity of laser light in a light-receiving portion.

Note that external light such as light from a usual lighting device and sun light is presumably incident on the display portion 103. To distinguish such external light from light for inputting information to an information terminal, the light for information input preferably has energy higher than the energy of the external light. Laser light is preferably used as the light having high energy.

For another example, the intensities of the energies of incident light are compared by a plurality of sensors inside or outside the display portion, and a region including a sensor detecting relatively higher energy than energy detected by the other sensors is assumed to be a user-selected region.

In addition, light having high directivity is preferably used so that the user can select a desired region of the display portion 103 and input information. Laser light is preferably used as such light having high directivity.

The sensor may detect not only the laser light 105 but also the touch of a user's finger or a stylus, that is, may serve as a touch sensor. Note that the touch here includes not only the direct touch of a finger or a touch pen on the display portion but also the approach of a finger or a touch pen to the vicinity of the display portion with no touch on the display portion. In addition, when the sensor detects the laser light 105, the information terminal 101 may display a pointer 106 in a region irradiated with the laser light.

An input unit 130 includes a support 109 and a laser device 107 provided on the support 109, and is fixed to a user's head or the like. In the example of this embodiment, the support 109 is designed to be mounted on the head so that the laser device 107 can be fixed to the head. This structure is preferable because the display portion 103 of the information terminal 101 can be irradiated with laser light in accordance with a user's line of sight. For another example, the laser device 107 of the input unit 130 may be fixed to part other than the head, such as neck, chest, shoulder, arm, hand, or finger in consideration of usability.

Preferably, the input unit 130 further includes a switch 111. The switch 111 connected to the laser device 107 with or without a wire can be used for information input to the information terminal 101. Alternatively, the switch 111 connected to the information terminal 101 with or without a wire may be used.

When the switch 111 is connected to the laser device 107, on/off of the laser device 107, the intensity, pulse width, and duty ratio of the laser light 105 output from the laser device 107, and the like can be changed with the switch 111. When the switch 111 is connected to the information terminal 101 and the operation of the switch 111 is performed in the state where the display portion 103 is irradiated with the laser light 105, the operation corresponding to the touch on a touch panel is assumed to occur at the portion irradiated with the laser light 105, so that information can be input like touch input. In addition, the switch 111 preferably includes two or more channels (e.g., Ch1, Ch2, and Ch3).

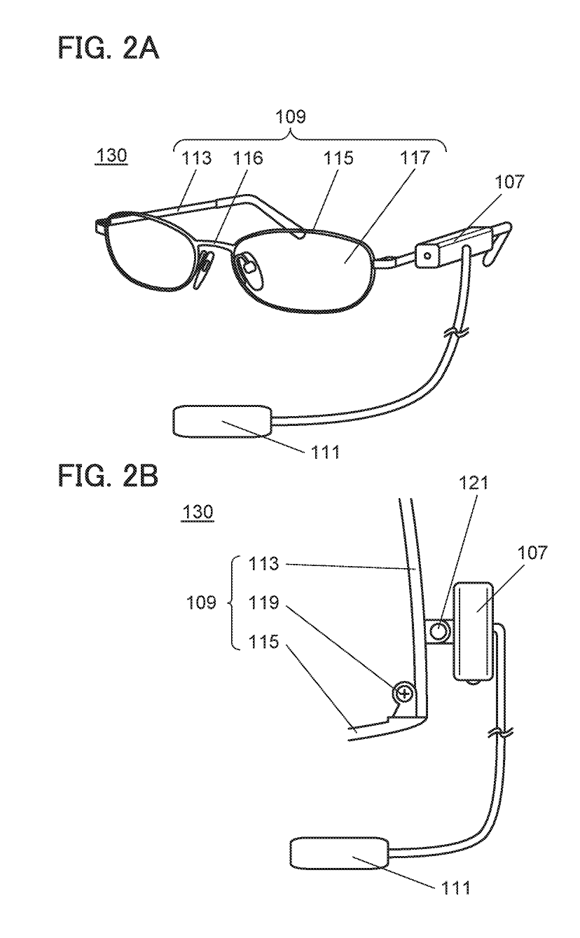

FIG. 2A is a diagram illustrating the input unit 130 in which eyeglasses are used as the support 109. The glasses include a temple 113, a rim 115, a bridge 116, lenses 117, and the like. The laser device 107 is fixed to the temple 113. However, this embodiment is not limited thereto. Based on the size and weight of the laser device 107, the laser device 107 may be fixed to the rim 115 or the bridge 116. The lenses 117 may have a function of correcting a user's vision or suppressing transmission of a certain wavelength. It is preferable that the lenses 117 can suppress transmission of, in particular, ultraviolet light with a wavelength of 400 nm or shorter and blue light with a wavelength from 380 nm to 500 nm among light emitted from the display portion of the information terminal, for example. Note that the lenses 117 is not necessarily provided.

FIG. 2B is an enlarged top view of the support 109 and the laser device 107 of the input unit 130. The temple 113 and the rim 115 are connected with a hinge 119 so that the input unit 130 is foldable to be stored. The laser device 107 may be provided on the support 109 with a movable portion 121 provided therebetween. The direction of the laser light output from the laser device 107 is adjusted with the movable portion 121 so that a user's line of sight can coincide with the portion on the display portion irradiated with the laser light.

As a power supply used for the laser device 107, a battery such as a primary battery or a secondary battery, a commercial power supply, or the like can be used. As the battery, a dry battery, a button battery, a laminated battery, or a battery pack packaged with resin or the like can be used. The battery may be incorporated in the laser device 107 or provided on the support 109. It is preferable to provide the power supply outside the laser device 107, in which the laser device 107 can be reduced in size and weight and the user can use the input unit 130 without feeling stress caused by the weight of the laser device 107. It is also preferable in that designability improves because there is no limitation on the installed position of the laser device 107. When a secondary battery, such as a secondary battery having a curved temple 113 or a shape-changeable secondary battery, is used as the power supply, the weight of the battery can be dispersed into the temples 113 on the both sides, which is preferable because the user can use the input unit 130 without feeling stress caused by the weight. The laser device 107 may be connected to the information terminal 101 and power may be supplied from the information terminal 101 to the laser device 107. A USB cable or the like can be used for the connection of the laser device 107 and the information terminal 101. Although not illustrated, the laser device 107 or a secondary battery used as the power supply is provided with a terminal for supplying power and charging.

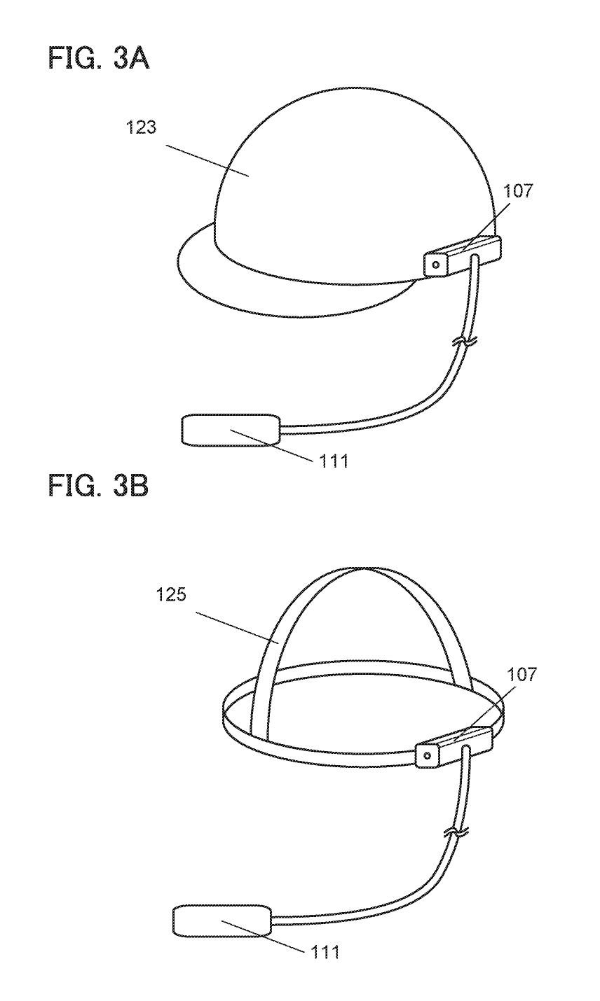

Although eyeglasses are used as the support 109 in the example of FIG. 1 and FIGS. 2A and 2B, the present invention is not limited thereto. As shown in FIG. 3A, a hat or a helmet may be used as a support 123. As shown in FIG. 3B, a head gear may be used as a support 125. In FIG. 3A, the laser device 107 is provided on the support 123 which is a hat or a helmet. The switch 111 is connected to the laser device 107 with or without a wire. Note that the laser device 107 is preferably provided on the support 123 with a movable portion provided therebetween (not illustrated here). The movable portion 121 illustrated in FIG. 2B can be referred to for the movable portion. Note that the installed position of the laser device is not limited to the temporal portion as illustrated and may be the front of the hat (forehead).

In FIG. 3B, the laser device 107 is provided on the support 125 which is a headgear or the like. The switch 111 is connected to the laser device 107 with or without a wire. Note that the laser device 107 is preferably provided on the support 125 with a movable portion provided therebetween (not illustrated here). The movable portion 121 illustrated in FIG. 2B can be referred to for the movable portion. Note that the installed position of the laser device is not limited to the temporal portion as illustrated and may be the front of the headgear (forehead).

FIG. 1, FIGS. 2A and 2B, and FIGS. 3A and 3B each illustrate an example in which the switch 111 is connected to the laser device 107 with a wire. As the switch 111, a switch for users with disabled hands or finger is preferable. For example, a breath switch, a push-button switch that can be operated by hand, arm, leg, mouth, chin, or the like, a pedal switch, a switch operated by grasping a rubber ball or the like, or a blink switch can be used.

For example, for a user who has difficulty or deficiency in the upper limb, a breath switch, a switch that can be operated with the mouth or chin, a pedal switch, or a blink switch can be used as the switch 111. For a user who has difficulty or deficiency in the leg, a breath switch, a switch that can be operated with the hand, arm, mouth, or chin, a switch operated by grasping a rubber ball or the like, or a blink switch can be used as the switch 111.

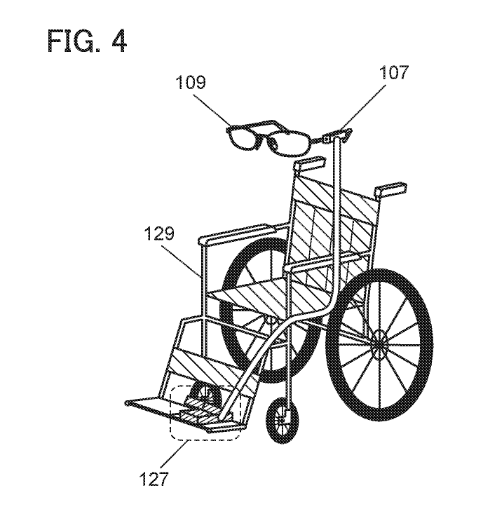

FIG. 4 illustrates an example in which the laser device 107 provided on the support 109 is connected with a wire to a pedal switch 127 as the switch 111. The pedal switch 127 may be put on the floor or mounted on a chair. In the example of this embodiment, the pedal switch 127 is mounted on a foot support of a wheel chair 129, and the user who has difficulty or deficiency in the upper limb can input information to the information terminal.

The switch 111 may be connected to the laser device 107 without a wire. The switch 111 may be connected to the information terminal 101 with or without a wire.

### <Input Operation 1>

Next, a method for inputting information to an information terminal using the above-mentioned input unit is described. Note that the input method in the description below is intended to be used by users who cannot freely move parts of the body (especially upper limbs, hands, and fingertips) or by users who have no feeling in the fingertips; however, users of the input method are not limited to them. The user may use the input method while inputting information to the information terminal using a keyboard, a mouse, a touch panel, or the like, or may input information to the information terminal by the input method while writing sentences with writing utensils such as a pen. Since laser light is used to input information, information may be input from a position away from the information terminal.

First, an embodiment in which the switch of the input unit is connected to the laser device will be described. In this embodiment, the laser light output from the laser device changes by the operation of the switch, whereby information is input to the information terminal.

The user wears the input unit of this embodiment and turns on the laser device while watching the display portion of the information terminal. When the input unit includes the support and the laser device provided on the support, the laser device is preferably provided on the support with the movable portion provided therebetween. The movable portion may be adjusted so that laser light output from the laser device can substantially coincide with a user's line of sight on the display portion of the information terminal.

In addition, when laser light output from the laser device is not detected on the display portion of the information terminal, an unintended portion might be irradiated with the laser light. In particular, it is dangerous to point laser light to the human body. It is preferable for safety that the information terminal send signals to the laser device to stop the output of the laser light.

The output of the laser light may be controlled by the switch.

The position of laser light is adjusted such that a specific region such as an icon displayed on the display portion of the information terminal is irradiated with laser light. In the state where the specific region is irradiated with the laser light, the user can control the switch connected to the laser device with or without a wire, thereby inputting information to the information terminal. Specifically, with the switch, the user can switch the intensity of laser light, the output method of laser light between continuous output and pulse output, the pulse width, or duty ratio in pulse output.

The sensor provided in the display portion of the information terminal detects the irradiation of laser light and the above-described change with the switch, and information is input to the information terminal like touch input on a touch panel, for example.

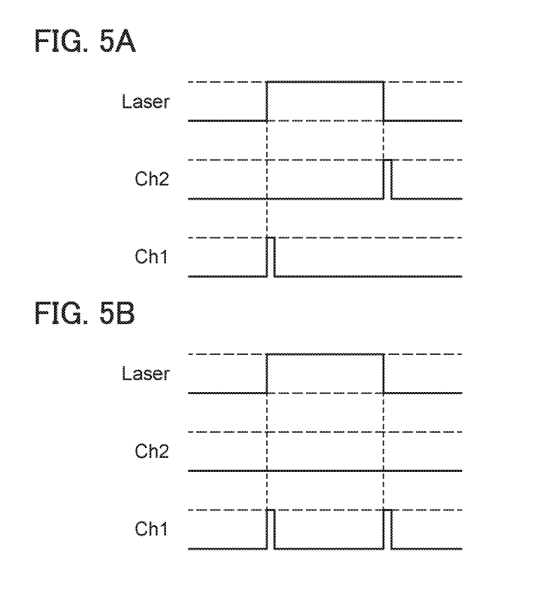

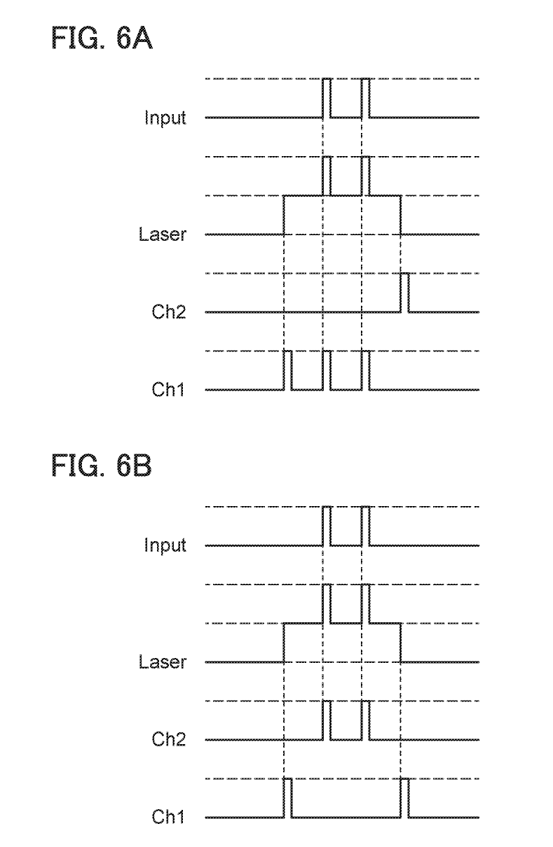

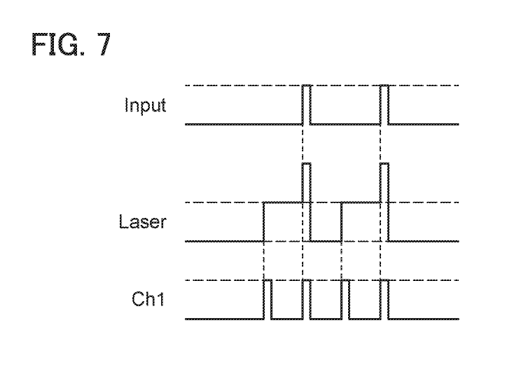

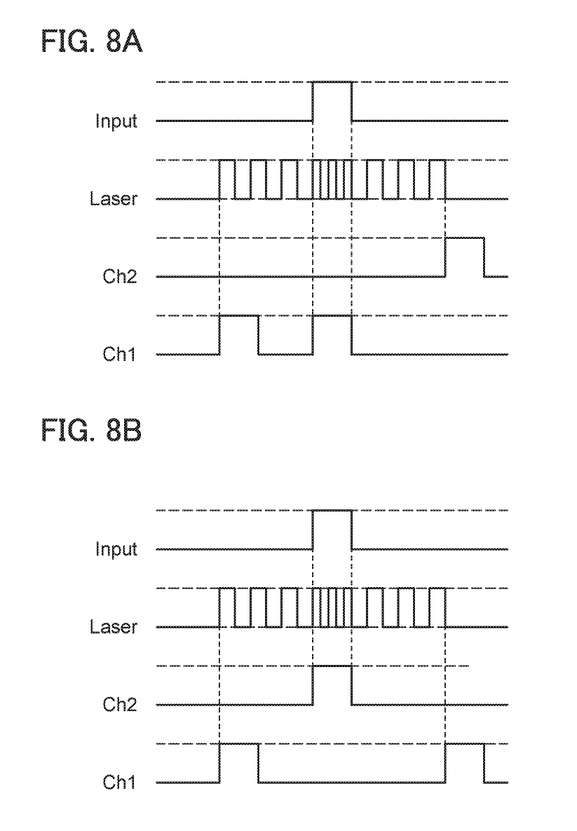

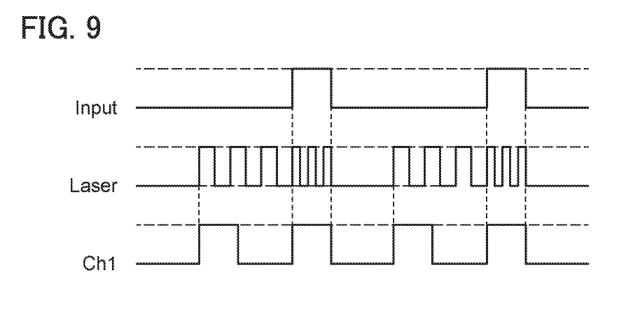

For example, FIG. 5A, FIGS. 6A and 6B, and FIGS. 8A and 8B are timing charts in the case where switches each having two channels (Ch1 and Ch2) are connected to a laser device and the switching of on/off of the laser device and switching of laser light are performed by the switches. Here, Ch1 and Ch2 mean that different signals are output from the switch by the operation of the switch. For example, in the case of the breath switch, puffing can be set as Ch1 and breathing can be set as Ch2. In the case of the push-button switch or the pedal switch, the switch includes a first button and a second button, and pushing the first button and pushing the second button can be set as Ch1 and Ch2, respectively. FIG. 5B, FIG. 7, and FIG. 9 are timing charts in the case where the switching of on/off of the laser device and switching of laser light are performed by the same switch (here, Ch1).

FIG. 5A illustrates an example where a laser device is turned on by Ch1 and is turned off by Ch2. Alternatively, as shown in FIG. 5B, the on/off of the laser device may be switched only by Ch1. In FIG. 5B, when the laser device is OFF before Ch1 operation, the laser device is turned on, whereas when the laser device is ON before Ch1 operation, the laser device is turned off.

FIG. 6A illustrates an example in which the laser device is turned on by operation of Ch1 and the output intensity of laser light is increased to input information to the information terminal by additional operation of Ch1. In FIG. 6A, the Ch1 operation is performed twice after the laser light is output; information is input twice to the information terminal, and then, the output of the laser light is terminated by Ch2 operation. The user can change a region which is irradiated with the laser light between the first information input and the second information input. The number of times of inputting information during one-time output of laser light, that is, the number of times of Ch1 operations may be one or three or more. The laser light which is output from the laser device by the first Ch1 operation can be referred to as first laser light. The laser light whose output intensity is increased by the second or later Ch1 operation can be referred to as second laser light. The sensor provided in the display portion of the information terminal detects at least the second laser light. Alternatively, the sensor detects the first laser light and the second laser light as different laser light. Such an operation enables users who cannot freely move parts of the body (especially upper limbs, hands, and fingertips) or users who have no feeling in the fingertips to easily input information to the information terminal.

FIG. 6B illustrates an example in which the laser device is turned on by Ch1 operation and the output intensity of laser light is increased by Ch2 operation to input information to the information terminal. In FIG. 6B, the Ch2 operation is performed twice after the laser light is output; information is input twice to the information terminal, and then, the output of the laser light is terminated by the Ch1 operation. The user can change a region which is irradiated with the laser light between the first information input and the second information input. The number of times of inputting information during output of laser light, that is, the number of times of Ch2 operation may be one or three or more. The laser light which is output from the laser device by the first Ch1 operation can be referred to as first laser light. The laser light whose output intensity is increased by the Ch2 operation can be referred to as second laser light. The sensor provided in the display portion of the information terminal detects at least the second laser light. Alternatively, the sensor detects the first laser light and the second laser light as different laser light. Such an operation enables users who cannot freely move parts of the body (especially upper limbs, hands, and fingertips) or users who have no feeling in the fingertips to easily input information to the information terminal.

FIG. 7 illustrates an example in which the output of laser light is turned off every input information to the information terminal by the operation of the switch. In this example, one channel is necessary for the switch (here, Ch1). The user operates the switch to output laser light from the laser device, so that a desired region of the display portion is irradiated with the laser light. When the user operates the switch again in the state where the desired region is irradiated with the laser light, the output intensity of the laser light is increased to perform information input to the information terminal, and then, the laser device is turned off. To subsequently perform information input, the switch is operated again to output laser light, and then the switch is operated in the state where a desired region is irradiated with the laser light, whereby second information input is performed. The laser light which is output from the laser device by the first Ch1 operation can be referred to as first laser light. The laser light whose output intensity is increased by the Ch1 operation can be referred to as second laser light. The sensor provided in the display portion of the information terminal detects at least the second laser light. Alternatively, the sensor detects the first laser light and the second laser light as different laser light.

According to this input method, the output of laser light is turned off every information input, which is preferable because the power consumption can be reduced or deterioration of the laser device due to a long-time output of laser light can be suppressed. Such an operation enables users who cannot freely move parts of the body (especially upper limbs, hands, and fingertips) or users who have no feeling in the fingertips to easily input information to the information terminal.

FIG. 8A illustrates an example in which the pulsed laser light having a first period is output from the laser device by the first Ch1 operation, and the pulse period of the laser light is switched to a second period by the second Ch1 operation, whereby input to the information terminal is performed. The sensor provided in the display portion of the information terminal detects laser light irradiation and the pulse of the laser light. When the pulse period of the laser light is changed by the second Ch1 operation, information input to the information terminal is performed like touch input on a touch panel, for example.

After the second Ch1 operation, i.e., after the information input, the pulse period of the laser light is switched to the first period. Then, the output of the laser light is terminated by Ch2 operation.

Although the laser light output from the laser device is pulsed laser light in the example of FIG. 8A, this embodiment is not limited thereto. The laser light in the information input or the laser light before and after the information input may be a continuous-output laser light.

Although the second period is shorter than the first period in the example of FIG. 8A, this embodiment is not limited thereto. The second period may be longer than the first period. Although the pulse period is switched in the example of this embodiment, the pulse duty ratio may be switched. Alternatively, both the period and the duty ratio may be switched.

Although the Ch1 operation is performed only once as the second Ch1 operation between the first Ch1 operation and the Ch2 operation in FIG. 8A, this embodiment is not limited thereto. The Ch1 operation may be performed twice or more after the pulsed laser light having the first period is output. In this case, the region irradiated with laser light may be changed in the second or later Ch1 operation. The laser light having the first period can be referred to as first laser light. The laser light having the second period can be referred to as second laser light. The sensor provided in the display portion of the information terminal detects at least the second laser light. Alternatively, the sensor detects the first laser light and the second laser light as different laser light. Such an operation enables users who cannot freely move parts of the body (especially upper limbs, hands, and fingertips) or users who have no feeling in the fingertips to easily input information to the information terminal.

FIG. 8B illustrates an example in which pulsed laser light having the first period is output from the laser device by the first Ch1 operation, and the pulse period of the laser light is switched to the second period by the Ch2 operation, whereby input to the information terminal is performed. The sensor provided in the display portion of the information terminal detects laser light irradiation and the pulse of the laser light. When the pulse period of the laser light is changed by the Ch2 operation, information input to the information terminal is performed like touch input on a touch panel, for example.

After the Ch2 operation, i.e., after the information input, the pulse period of the laser light is switched to the first period. Then, the output of the laser light is terminated by the second Ch1 operation.

Although the laser light output from the laser device is pulsed laser light in the example of FIG. 8B, this embodiment is not limited thereto. The laser light in the information input or the laser light before and after the information input may be a continuous-output laser light.

Although the second period is shorter than the first period in the example of FIG. 8B, this embodiment is not limited thereto. The second period may be longer than the first period. Although the pulse period is switched in the example of this embodiment, the pulse duty ratio may be switched. Alternatively, both the period and the duty ratio may be switched.

Although the Ch2 operation is performed only once between the first Ch1 operation and the second Ch1 operation in FIG. 8B, this embodiment is not limited thereto. The Ch2 operation may be performed twice or more after the pulsed laser light having the first period is output. In this case, the region irradiated with laser light may be changed in the second or later Ch2 operation. The laser light having the first period can be referred to as first laser light. The laser light having the second period can be referred to as second laser light. The sensor provided in the display portion of the information terminal detects at least the second laser light. Alternatively, the sensor detects the first laser light and the second laser light as different laser light. Such an operation enables users who cannot freely move parts of the body (especially upper limbs, hands, and fingertips) or users who have no feeling in the fingertips to easily input information to the information terminal.

FIG. 9 illustrates an example in which the output of laser light is turned off every input information to the information terminal by the operation of the switch. In this example, one channel is necessary for the switch (here, Ch1). The user operates the switch to output pulsed laser light having the first period from the laser device, so that a desired region of the display portion is irradiated with the laser light. When the user operates the switch again in the state where the desired region is irradiated with the laser light, the laser light is switched to pulsed laser light having the second period to perform information input to the information terminal, and then, the laser device is turned off. To subsequently perform information input, the switch is operated again to output laser light, and then the switch is operated in the state where a desired region is irradiated with the laser light, whereby second information input is performed.

Although the laser light output from the laser device is pulsed laser light in the example of FIG. 9, this embodiment is not limited thereto. The laser light in the information input or the laser light before the information input may be a continuous-output laser light.

Although the second period is shorter than the first period in the example of FIG. 9, this embodiment is not limited thereto. The second period may be longer than the first period. Although the pulse period is switched in the example of this embodiment, the pulse duty ratio may be switched. Alternatively, both the period and the duty ratio may be switched. The laser light having the first period can be referred to as first laser light. The laser light having the second period can be referred to as second laser light. The sensor provided in the display portion of the information terminal detects at least the second laser light. Alternatively, the sensor detects the first laser light and the second laser light as different laser light.

According to this input method, the output of laser light is turned off every information input, which is preferable because the power consumption can be reduced or deterioration of the laser device due to a long-time output of laser light can be suppressed. Such an operation enables users who cannot freely move parts of the body (especially upper limbs, hands, and fingertips) or users who have no feeling in the fingertips to easily input information to the information terminal.

### <Input Operation 2>

Next, an embodiment in which a switch of the input unit is connected to the information terminal with or without a wire is described. In this embodiment, by the operation of the switch, the sensor provided in the display portion of the information terminal detects the laser light output from the laser device and inputs information to the information terminal.

A specific region such as an icon displayed on the display portion of the information terminal is irradiated with laser light by the user. In the state where the specific region is irradiated with the laser light, the user can control the switch connected to the information terminal with or without a wire, thereby inputting information to the information terminal. Specifically, the information terminal reads a sensor irradiated with laser light when the switch is operated, and information is input to the information terminal from the sensor.

Note that the switch may be connected not only to the information terminal but also to the laser device. With such a structure, not only information input but also laser light output can be controlled by the switch. Here, the switch preferably includes two or more channels. Such an operation enables users who cannot freely move parts of the body (especially upper limbs, hands, and fingertips) or users who have no feeling in the fingertips to easily input information to the information terminal.

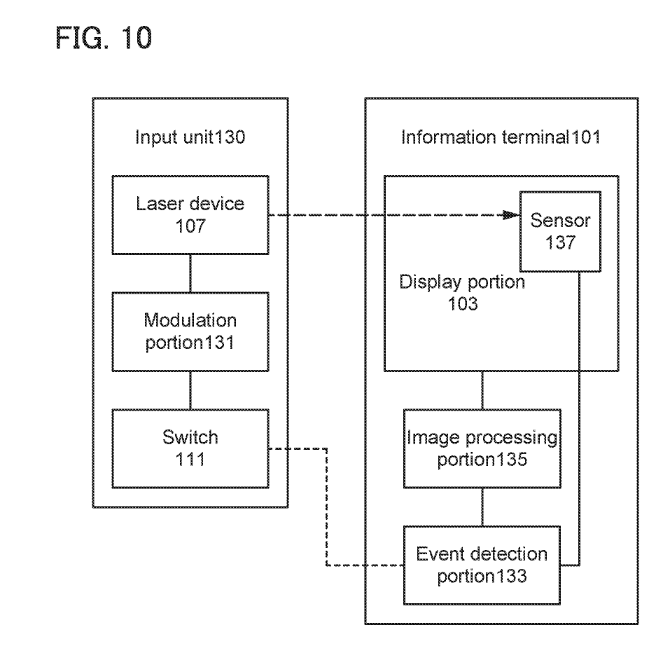

FIG. 10 is a block diagram illustrating an information terminal, an input unit, and an input method of one embodiment of the present invention.

The input unit 130 includes the laser device 107, a modulation portion 131, and the switch 111. The switch 111 is used for switching on/off of the laser device 107 and the intensity or pulse period of laser light output from the laser device 107. An event signal may be transmitted to the information terminal 101 by the operation of the switch. The modulation portion 131 changes the amplitude, phase, width, and position of the laser device 107, whereby the intensity or pulse period of the output laser light is switched.

The information terminal 101 includes the display portion 103, an event detection portion 133, and an image processing portion 135. The display portion 103 includes a sensor 137. When irradiated with laser light output from the laser device 107, the sensor 137 outputs a signal to the event detection portion 133. The event detection portion detects whether information is input to the information terminal 101 on the basis of the presence or absence of a signal input from the sensor 137, the level of the signal, the pulse period of the signal, and the like. The event detection portion may be configured to receive a signal from the switch 111 provided in the input unit 130 to detect whether or not information is input to the information terminal 101. The event detection portion may transmit a signal to the input unit 130 to control the laser device 107. For example, in the case where the event detection portion does not receive a laser-light detection signal from the sensor 137 even when the laser device 107 is turned on, i.e., when the laser light is output, the event detection portion can turn off the laser device 107. The laser device 107 may be controlled through the switch 111. Such a structure is preferable for safety because regions other than the display portion, an object, a human, and the like can be prevented from being irradiated with laser light.

The image processing portion 135 generates an image based on the above-described event and inputs an image signal to the display portion 103 through a source driver or a gate driver. For example, the image processing portion 135 can display, on the display portion, a pointer on a region of the display portion 103 irradiated with laser light, application, an image such as a photograph or an illustration, a moving image such as video or movie, various kinds of information, input buttons such as a keyboard.

### <Input Position Detection Method>

The laser light 105 which is output from the laser device 107 provided in the input unit 130 is detected by the sensor provided in the display portion 103 of the information terminal 101. By the operation of the switch 111, information is input from the sensor irradiated with the laser light 105 to the information terminal.

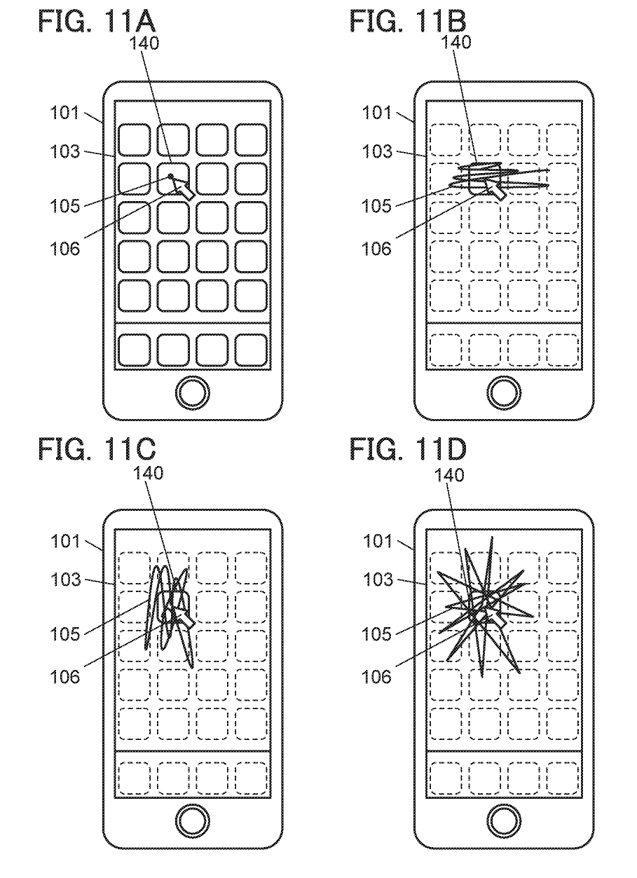

FIG. 11A illustrates the information terminal 101. Icons 140 are displayed on the display portion 103 of the information terminal 101. Note that each icon 140 functions as a button for executing application or a program or as a keyboard for inputting characters and symbols. The user controls the input unit so that a desired icon 140 is irradiated with the laser light 105. When the sensor provided in the display portion 103 detects the laser light 105, the information terminal 101 displays the pointer 106 in the region. The user can input information to the information terminal by the switch control after seeing the region where the pointer 106 is displayed. At this time, the information may be input to the information terminal after the intensity or pulse period of the laser light is changed by the switch control. Alternatively, the switch and the information terminal are connected with or without a wire, and information may be input from the region irradiated with the laser light 105 or the region where the pointer 106 is displayed to the information terminal.

It is difficult for users who quiver uncontrollably at the mounted position of the input unit 130 to perform laser irradiation on a desired region. For example, there are tremor of the head of a user wearing the input unit 130 whose support is a hat, a helmet, a headgear, or the like, and tremor of the upper limb of a user wearing the input unit 130 on the arm. In such a condition, the laser light 105 with which the display portion 103 is irradiated wavers, and laser irradiation to a desired region is difficult. As the distance between the display portion 103 and the input unit 130 is increased, wavering of the laser light 105 with which the display portion 103 is irradiated becomes larger. In other words, it is probably difficult to perform laser irradiation to a desired region even for users with no physical handicap.

Such wavering of the laser light 105 makes user's input work complicated and might cause an input error.

Regardless of whether the user has a physical handicap or not, there seems to be specific patterns in the tremor of a user's head or upper limb. FIG. 11B illustrates the input work of a user who tends to quiver laterally. The laser light 105 goes out of a desired icon 140 indicated by a solid line and the adjacent icons 140 shown by dotted lines are also irradiated with the laser light 105. FIG. 11C illustrates the input work of a user who tends to quiver vertically. The laser light 105 goes out of a desired icon 140 indicated by a solid line and the adjacent icons 140 shown by dotted lines are also irradiated with the laser light 105. FIG. 11D illustrates the input work of a user whose tremor does not have a tendency in direction. The laser light 105 goes out of a desired icon 140 indicated by a solid line and the adjacent icons 140 shown by dotted lines are also irradiated with the laser light 105.

In view of the above, using the AI, an input support system can be provided which predicts a region where a user intends to point, i.e., an icon (hereinafter referred to as input position) where the user wants to perform input even when the laser light 105 wavers. The user performs input to the information terminal using the switch or the like when the input position predicted by the input support system is correct. Thus, the input support system using artificial intelligence can make input work easier and can prevent an input error. Furthermore, the artificial intelligence can learn an input pattern for each user and store the pattern. An ID may be assigned for each pattern. The AI that learns and stores input patterns can fit the movement of the laser light to a user's pattern as input support. In addition, the artificial intelligence compares the movement of the laser light with patterns stored by the AI to identify the user performing the input operation.

When the artificial intelligence predicts the input position, the information terminal can display the pointer 106 on the region or icon. The user sees the position of the displayed pointer 106 and then operates the switch. At this time, the information may be input to the information terminal after the intensity or pulse period of the laser light 105 is changed by the switch control. Even if the region irradiated with laser light goes out of the pointer 106 at the switch operation, the user can input information at the region where the pointer 106 is displayed. At this time, a sensor in a different position from the region where the pointer 106 is displayed detects the operation of the switch. Alternatively, the switch and the information terminal are connected with or without a wire, and information may be input from the region irradiated with the laser light 105 or the region where the pointer 106 is displayed to the information terminal. Note that the artificial intelligence may be provided in the information terminal 101 or may be provided in a computer, a server, or the input portion 130 which are capable of communication with the information terminal 101 with or without a wire.

The pointer displayed in the display portion 103 does not need to chase the wavering of the laser light 105. The input position is identified as follows: a region or icon irradiated with the laser light 105 more times for a certain time (from 1 second to several seconds), a region or icon irradiated with the laser light 105 for a longer time, the center of the width of wavering of the laser light 105, the center of the region irradiated with the laser light 105, and the like are calculated to summarize data. As a result of comprehensive determination from one or more of the data, the pointer 106 can be displayed on the display portion 103.

In addition to the direction of wavering of the laser light 105, a plurality of pieces of data such as the width of wavering and the period of reciprocating wavering, and the like, that is, deeper data are collected, and the movement pattern of the laser light 105 can be extracted and stored from the data. Such a method of extracting and storing a pattern from a plurality of pieces of data is referred to as deep learning (DL). In the DL, deep neural network (DNN) is preferably used. In the DNN, a plurality of pieces of data are classified, user information is extracted class by class, and the user information can be stored. In addition, when the user information is stored in the information terminal, a computer, or a server, the movement pattern of the laser light 105 during the input is determined class by class to identify the user. The use of the DNN can store user information more accurately and can identify the user inputting information. Moreover, even when a plurality of users input information to one display portion at the same time, the respective movement patterns of laser light are read, so that the user can be identified.

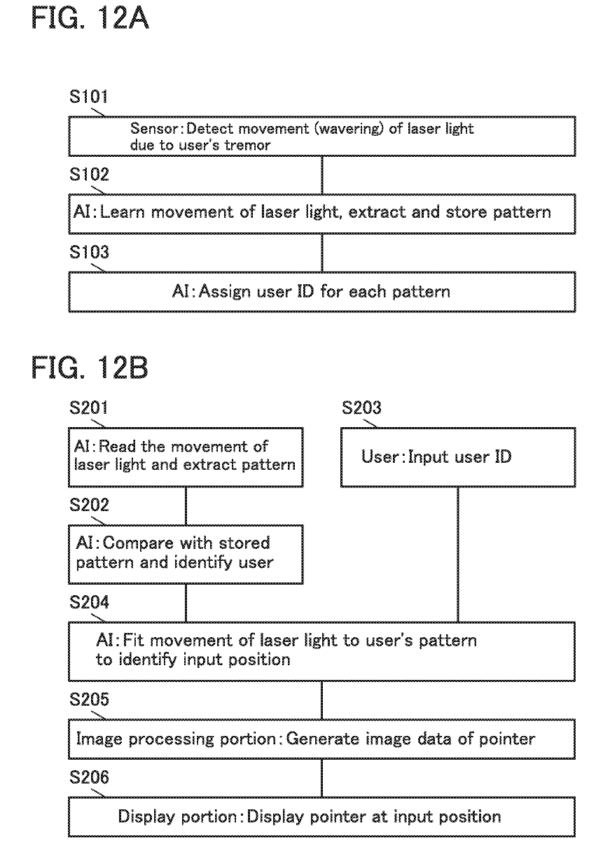

FIGS. 12A and 12B are flow charts showing input support and user registration using artificial intelligence.

With reference to FIG. 12A, a description is given for learning of the movement of laser light and assignment of user IDs by artificial intelligence. The sensor provided in the display portion 103 detects the laser light 105 output from the input unit 130. At this time, the sensor also detects the movement (wavering) of the laser light 105 due to the tremor of a user's head or upper limb (S101).

Information detected by the sensor is transmitted to artificial intelligence (AI) provided in the information terminal 101, a computer or a server that can communicate with the information terminal 101 with or without a wire, or the input unit 130. The artificial intelligence learns the movement of laser light, extracts patterns for items such as the direction, degree of wavering, and period of the movement of laser light, and stores the pattern (S102).

The artificial intelligence assigns an ID to a user on the basis of the extracted and stored pattern (S103). In the case where there are a plurality of users whose information is to be input to the information terminal 101, the above steps are repeated to assign a user ID for each pattern.

With reference to FIG. 12B, a description is given for a method of user identification and input support on the basis of the stored pattern.

When a user starts input to the information terminal 101 with the input unit 130, the artificial intelligence (AI) reads the movement of the laser light 105 and extracts the pattern (S201).

The artificial intelligence compares the extracted pattern with the stored patterns to identify the user from the pattern matching with the extracted pattern (S202). Alternatively, the user may input a user ID assigned in advance to the information terminal 101 (S203).

The artificial intelligence fits the movement of laser light to a user's pattern to identify the input position (S204).

The information on the identified input position is transmitted to the image processing portion 135, and the image processing portion 135 generates image data of the pointer 106 corresponding to input position (S205).

The generated image data is transmitted to the display portion 103, and the pointer 106 is displayed at the input position (S206).

When the displayed pointer 106 points a desired icon, the user can input information to the information terminal by switch operation. In this manner, learning and storing user information by artificial intelligence as input support enable the user to perform input more easily, and can reduce an input error.

At least part of the contents described in this embodiment can be combined with any of the other embodiments.

### Embodiment 2

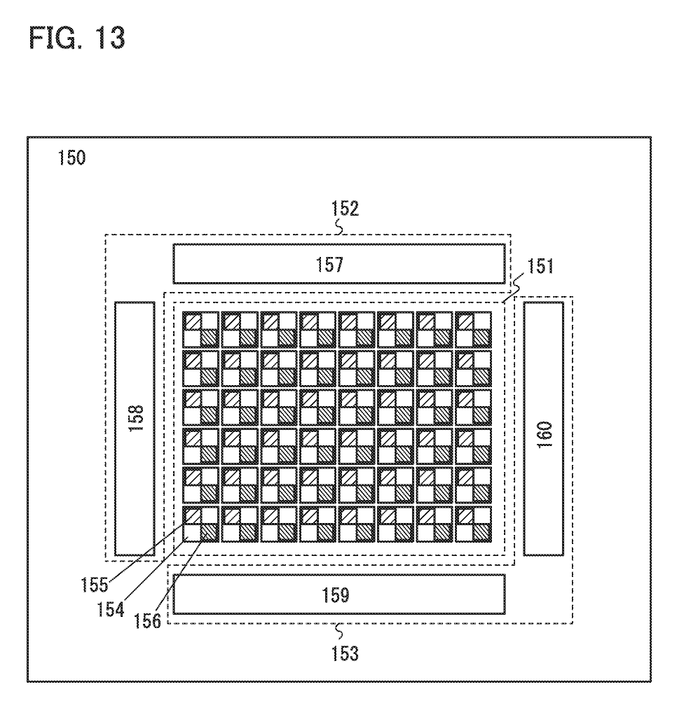

In this embodiment, a circuit configuration of a display portion of the information terminal that can be used in the present invention is described with reference to FIG. 13 to FIG. 16. In this embodiment, an example of using a photosensor as a sensor included in the display portion is shown. The photosensor detects laser light output from an input unit.

FIG. 13 illustrates the structure of the display portion. A display panel 150 includes a pixel circuit 151, a display element control circuit 152, and a photosensor control circuit 153.

The pixel circuit 151 corresponds to the display portion 103 in FIG. 1 and includes a plurality of pixels 154 arranged in a matrix of rows and columns. Each of the pixels 154 includes a display element 155 and a photosensor 156. The photosensor is not necessarily provided for each of the pixels 154, and may be provided for a plurality of pixels. Alternatively, the photosensor may be provided outside the pixels 154.

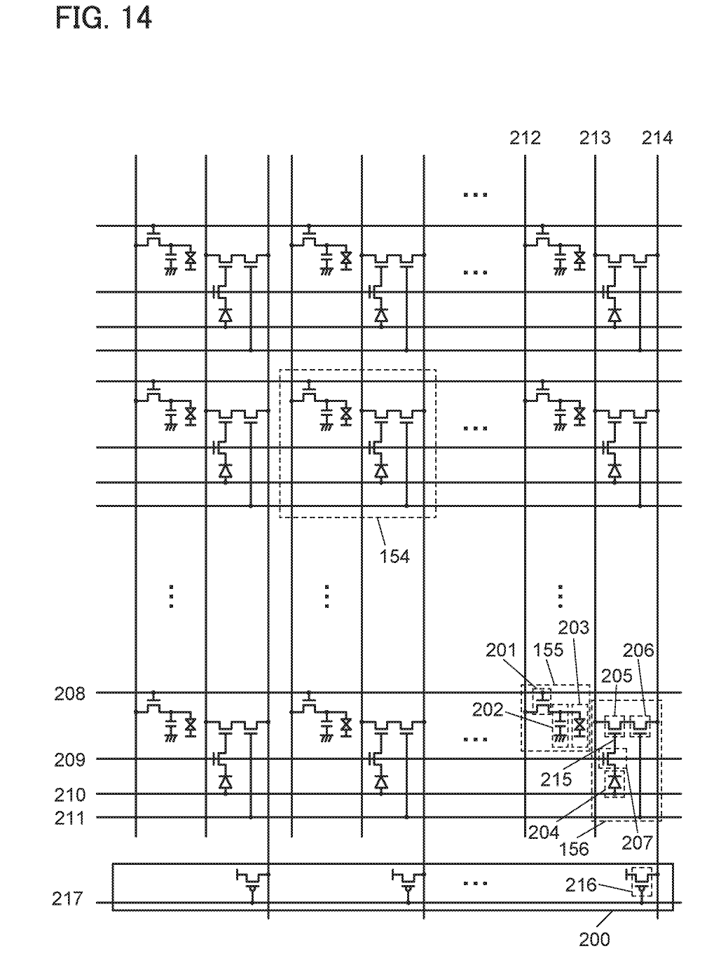

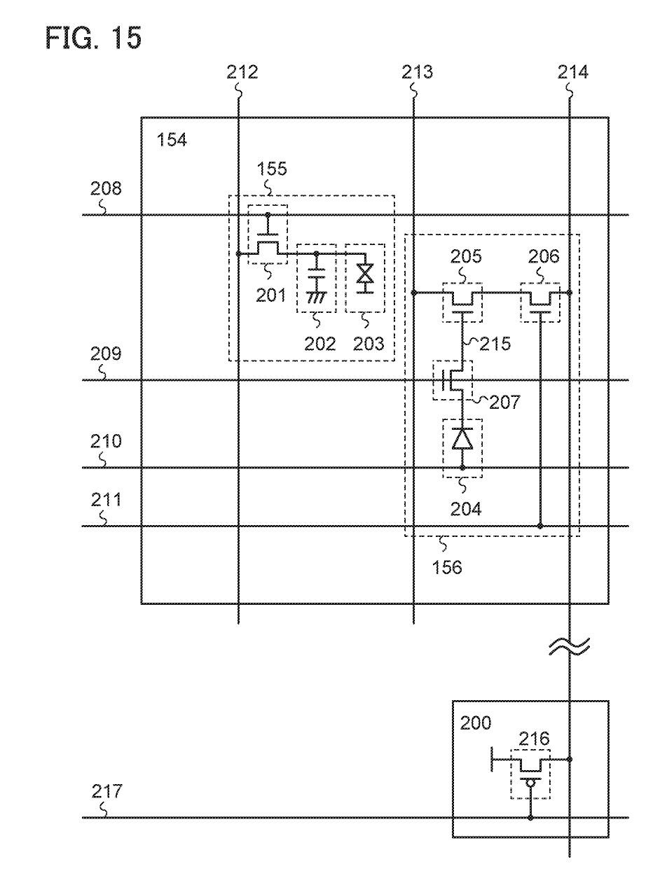

A circuit diagram of the pixel 154 will be described with reference to FIG. 14 and FIG. 15. Note that FIG. 15 is an enlarged view of the pixel 154 in FIG. 14. The pixel 154 includes the display element 155 including a transistor 201, a storage capacitor 202, and a liquid crystal element 203; and the photosensor 156 including a photodiode 204 which is a light-receiving element, a transistor 205, a transistor 206, and a transistor 207.

In the display element 155, a gate of the transistor 201 is electrically connected to a gate signal line 208, one of a source and a drain of the transistor 201 is electrically connected to a video data signal line 212, and the other of the source and the drain is electrically connected to one electrode of the storage capacitor 202 and one electrode of the liquid crystal element 203. The other electrode of the storage capacitor 202 and the other electrode of the liquid crystal element 203 are each held at a certain potential. The liquid crystal element 203 includes a pair of electrodes and a liquid crystal layer sandwiched between the pair of electrodes.

The transistor 201 has a function of controlling injection or release of charges to or from the storage capacitor 202. For example, when a high potential is applied to the gate signal line 208, the potential of the video data signal line 212 is applied to the storage capacitor 202 and the liquid crystal element 203. The storage capacitor 202 has a function of retaining charge corresponding to a voltage applied to the liquid crystal element 203. The contrast (gray scale) of light passing through the liquid crystal element 203 is made by utilizing the change in the alignment direction of liquid crystal molecules contained in the liquid crystal layer due to voltage application to the liquid crystal element 203, whereby image display is realized. As the light passing through the liquid crystal element 203, light emitted from a light source (a backlight) on the side opposite to the display surface of the liquid crystal display device is used.

The transistor 201 includes a semiconductor, such as a semiconductor containing silicon, an oxide semiconductor, or a compound semiconductor. There is no limitation on the crystallinity of the semiconductor, and an amorphous semiconductor, a microcrystal semiconductor, a polycrystalline semiconductor, a single crystal semiconductor, or the like can be used. In particular, display quality can be increased by using an oxide semiconductor to obtain a transistor with an extremely low off-state current.

Although the display element 155 described here includes the liquid crystal element, it may include other elements such as a light-emitting element. The light emitting element is an element in which the luminance is controlled by current or voltage. Specifically, a light emitting diode, an OLED (organic light emitting diode), and the like can be given.

In the photosensor 156, one electrode of the photodiode 204 is electrically connected to a photodiode reset signal line 210, and the other electrode of the photodiode 204 is electrically connected to one of a source and a drain of the transistor 207. One of a source and a drain of the transistor 205 is electrically connected to a photosensor reference signal line 213, and the other of the source and the drain of the transistor 205 is electrically connected to one of a source and a drain of the transistor 206. A gate of the transistor 206 is electrically connected to a gate signal line 211, and the other of the source and the drain of the transistor 206 is electrically connected to a photosensor output signal line 214. A gate of the transistor 207 is electrically connected to a gate signal line 209, and the other of the source and the drain of the transistor 207 is electrically connected to a gate of the transistor 205.

The photodiode 204 includes a semiconductor, such as a semiconductor containing silicon, an oxide semiconductor, or a compound semiconductor. There is no limitation on the crystallinity of the semiconductor, and an amorphous semiconductor, a microcrystal semiconductor, a polycrystalline semiconductor, a single crystal semiconductor, or the like can be used. In particular, a single crystal semiconductor (e.g., single crystal silicon) with few crystal defects is preferably used so as to improve the proportion of an electric signal generated from incident light (the quantum efficiency). As the semiconductor material, it is preferable to use silicon or a semiconductor containing silicon such as silicon germanium, the crystallinity of which can be easily increased.

The transistor 205 includes a semiconductor, such as a semiconductor containing silicon, an oxide semiconductor, or a compound semiconductor. There is no limitation on the crystallinity of the semiconductor, and an amorphous semiconductor, a microcrystal semiconductor, a polycrystalline semiconductor, a single crystal semiconductor, or the like can be used. In particular, a single crystal semiconductor is preferably used so that the transistor 205 has high mobility and has a function of converting a charge supplied from the photodiode 204 into an output signal. As the semiconductor material, it is preferable to use silicon or a semiconductor containing silicon such as silicon germanium, the crystallinity of which can be easily increased.

The transistor 206 includes a semiconductor, such as a semiconductor containing silicon, an oxide semiconductor, or a compound semiconductor. There is no limitation on the crystallinity of the semiconductor, and an amorphous semiconductor, a microcrystal semiconductor, a polycrystalline semiconductor, a single crystal semiconductor, or the like can be used. In particular, a single crystal semiconductor is preferably used so that the transistor 206 has high mobility and has a function of supplying an output signal of the transistor 205 to the photosensor output signal line 214. As the semiconductor material, it is preferable to use silicon or a semiconductor containing silicon such as silicon germanium, the crystallinity of which can be easily increased.

The transistor 207 includes a semiconductor, such as a semiconductor containing silicon, an oxide semiconductor, or a compound semiconductor. There is no limitation on the crystallinity of the semiconductor, and an amorphous semiconductor, a microcrystal semiconductor, a polycrystalline semiconductor, a single crystal semiconductor, or the like can be used. In particular, an oxide semiconductor is preferably used so that the transistor 207 has an extremely low off-current and has a function of retaining a charge of the gate of the transistor 205. When many kinds of transistors are thus disposed in accordance with the functions necessary for the transistors, the performance of the photosensor can be improved.

The display element control circuit 152 controls the display elements 155 and includes a display element driver circuit 157 and a display element driver circuit 158. The display element driver circuit 157 inputs a signal to the display elements 155 through signal lines (also referred to as “source signal lines”) such as video data signal lines. For example, the display element driver circuit 158 electrically connected to the scan line has a function of selecting a display element included in a pixel in a specified row. The display element driver circuit 157 electrically connected to the signal line has a function of supplying a predetermined potential to a display element included in a pixel in a selected row. Note that in the display element connected to the gate signal line to which a high potential is applied from the display element driver circuit 158, the transistor is turned on and supplied with a potential applied to the video data signal line from the display element driver circuit 157.

The photosensor control circuit 153 is a circuit for controlling the photosensor 156, and includes a photosensor reading circuit 159 electrically connected to the signal line such as the photosensor output signal line or the photosensor reference signal line; and a photosensor driver circuit 160 electrically connected to the scan line.

The photosensor driver circuit 160 has a function of performing the hereinafter described reset operation, accumulation operation, and selection operation on the photosensor 156 included in a pixel in a specified row.

The photosensor reading circuit 159 connected to the signal line has a function of extracting an output signal of the photosensor 156 included in the pixel in the selected row. Note that from the photosensor reading circuit 159, an output of the photosensor 156, which is an analog signal, is extracted as it is to the outside of the display panel with the use of an OP amplifier. Alternatively, the output is converted into a digital signal with the use of an A/D converter circuit and then extracted to the outside of the display panel.

A precharge circuit included in the photosensor reading circuit 159 will be described with reference to FIG. 14 and FIG. 15. Note that FIG. 15 is an enlarged view of the pixel 154 in FIG. 14. In FIG. 14 and FIG. 15, a precharge circuit 200 for one column of pixels includes a transistor 216 and a precharge signal line 217. Note that the photosensor reading circuit 159 may include an OP amplifier or an A/D converter circuit connected to a subsequent stage of the precharge circuit 200.

In the precharge circuit 200, before the operation of the photosensor in the pixel, the potential of the photosensor output signal line 214 is set at a reference potential. In FIG. 14 and FIG. 15, the transistor 216 is p-type and the precharge signal line 217 is set to “L (Low)” so that the transistor 216 is turned on, whereby the potential of the photosensor output signal line 214 can be set to a reference potential (here, a high potential). Note that it is effective to provide a storage capacitor for the photosensor output signal line 214 so that the potential of the photosensor output signal line 214 is stabilized. Note that the reference potential can also be a low potential. In that case, the transistor 216 is n-type and the precharge signal line 217 is set to “H (High)”, whereby the potential of the photosensor output signal line 214 can be set to a reference potential.

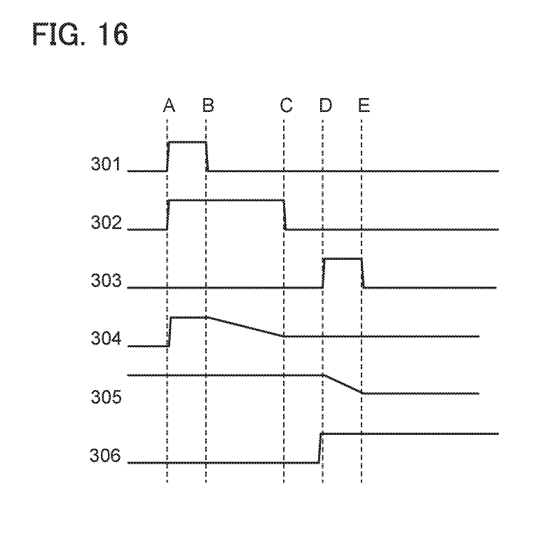

Next, an operation of the photosensor 156 is described below using timing charts shown in FIG. 16. In FIG. 16, a signal 301, a signal 302, a signal 303, a signal 304, a signal 305, and a signal 306 respectively correspond to the potentials of the photodiode reset signal line 210, the gate signal line 209, the gate signal line 211, the gate signal line 215, the photosensor output signal line 214, and the precharge signal line 217 which are shown in FIG. 14 and FIG. 15.

At time A, the potential of the photodiode reset signal line 210 (the signal 301) is set to “H” and the potential of the gate signal line 209 (the signal 302) is set to “H” (reset operation is started); then, the photodiode 204 is turned on and the potential of the gate signal line 215 (the signal 304) becomes “H”. When the potential of the precharge signal line 217 (the signal 306) is “L”, the potential of the photosensor output signal line 214 (the signal 305) is precharged to “H”.

At time B, the potential of the photodiode reset signal line 210 (the signal 301) is set to “L” and the potential of the gate signal line 209 (the signal 302) is kept at “H” (the reset operation is completed and accumulation operation is started); then, the potential of the gate signal line 215 (the signal 304) starts to decrease because of the off-current of the photodiode 204. Since the off-current of the photodiode 204 increases as light enters, the potential of the gate signal line 215 (the signal 304) changes depending on the amount of incident light. In other words, the photodiode 204 has a function of supplying a charge in accordance with the intensity of incident laser light to the gate of the transistor 205. Then, the channel resistance between the source and the drain of the transistor 205 changes.

Note that external light such as light from a usual lighting device and sun light is presumably incident on the photodiode 204. To distinguish such external light from light for inputting information to an information terminal, the light for information input preferably has energy higher than the energy of the external light. Laser light is preferably used as the light having high energy.

For another example, the intensities of the energies of incident light are compared by a plurality of photodiodes inside or outside the display portion, and a region including a photodiode detecting relatively higher energy than energy detected by the other photodiodes is assumed to be a user-selected region.

At time C, the potential of the gate signal line 209 (the signal 302) is set to “L” (the accumulation operation is completed); then, the potential of the gate signal line 215 (the signal 304) becomes constant. This potential is determined by the charge that has been supplied to the gate signal line 215 from the photodiode 204 during the accumulation operation. That is, the amount of charge accumulated in the gate of the transistor 205 changes depending on the intensity of laser light entering the photodiode 204. In addition, the transistor 207 uses an oxide semiconductor so as to have an extremely low off-current; consequently, the accumulated charge can be kept constant until the subsequent selection operation.

At time D, the potential of the gate signal line 211 (the signal 303) is set to “H” (the selection operation is started); then, the transistor 206 is turned on and electrical conduction is established between the photosensor reference signal line 213 and the photosensor output signal line 214 through the transistor 205 and the transistor 206. Then, the potential of the photosensor output signal line 214 (the signal 305) decreases. Note that before the time D, the potential of the precharge signal line 217 (the signal 306) is set to “H” so that the precharge of the photosensor output signal line 214 is completed. The rate at which the potential of the photo sensor output signal line 214 (the signal 305) is lowered depends on the current between the source and the drain of the transistor 205, namely, the amount of light that is emitted to the photodiode 204 during the accumulation operation.

At time E, the potential of the gate signal line 211 (the signal 303) is set to “L” (the selection operation is completed); then, the transistor 206 is turned off and the potential of the photosensor output signal line 214 (the signal 305) becomes constant. The constant value here changes depending on the amount of light that is emitted to the photodiode 204. Thus, the amount of light entering the photodiode 204 during the accumulation operation can be determined by obtaining the potential of the photosensor output signal line 214.

In the above manner, the operation of individual photosensors is realized by repeatedly performing the reset operation, the accumulation operation, and the selecting operation. The transistor 207 controlling the accumulation operation preferably uses an oxide semiconductor to have an extremely low off-current as described above. With such a circuit configuration, the function of retaining the charge accumulated in the gate of the transistor 205 can be improved. Therefore, the photosensor 156 can accurately convert incident light into an electric signal.

### Modification Example

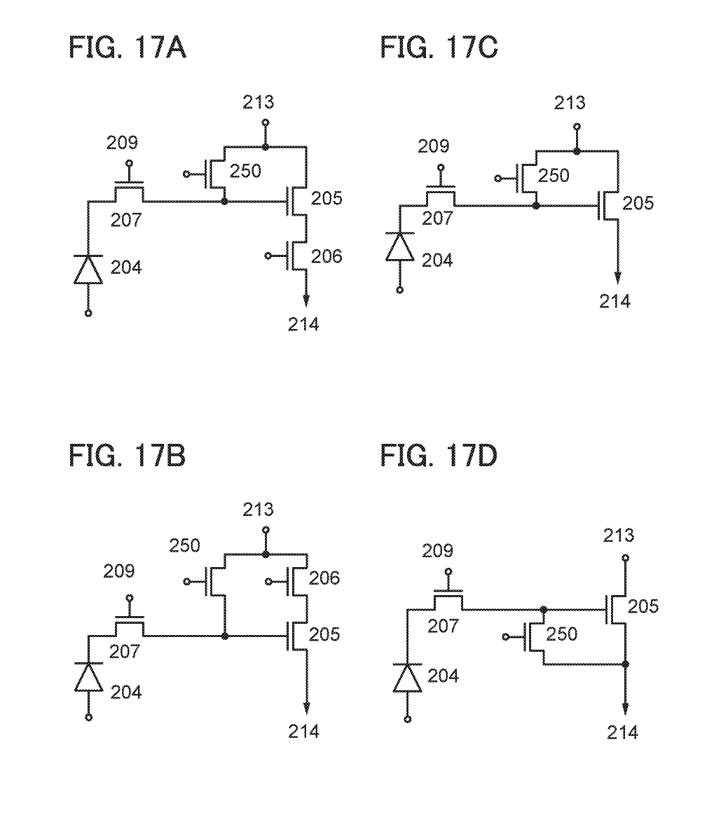

Next, modification examples of the circuit configuration of the photosensor 156 in FIG. 14 and FIG. 15 are described with reference to FIGS. 17A and 17B.

FIG. 17A illustrates a structure in which the gate of the transistor 205 in FIG. 14 and FIG. 15 is connected to a transistor 250 for controlling the reset operation of the photosensor. Specifically, one of a source and a drain of the transistor 250 is electrically connected to the photosensor reference signal line 213 and the other thereof is electrically connected to the gate of the transistor 205. One electrode of the photodiode 204 is electrically connected to a wiring to which a predetermined potential (e.g., a ground potential) is applied.

The transistor 250 includes a semiconductor, such as a semiconductor containing silicon, an oxide semiconductor, or a compound semiconductor. There is no limitation on the crystallinity of the semiconductor, and an amorphous semiconductor, a microcrystal semiconductor, a polycrystalline semiconductor, a single crystal semiconductor, or the like can be used. In particular, an oxide semiconductor is preferably used for the transistor 250 so that off current of the transistor 250 is low and charge of the gate of the transistor 205 is prevented from being released through the transistor 250 after the reset operation.

FIG. 17B illustrates a structure in which the transistor 205 and the transistor 206 are connected to be opposite to those in FIG. 17A. Specifically, one of the source and the drain of the transistor 205 is electrically connected to the photosensor output signal line 214, and one of the source and the drain of the transistor 206 is electrically connected to the photosensor reference signal line 213.

FIG. 17C illustrates a structure in which the transistor 206 is omitted from the structure in FIG. 17A. Specifically, one of the source and the drain of the transistor 205 is electrically connected to the photosensor reference signal line 213 and the other thereof is electrically connected to the photosensor output signal line 214.

Note that in FIGS. 17A to 17C, one of the source and the drain of the transistor 250 may be electrically connected to a wiring other than the photosensor reference signal line 213.

In FIG. 17D, one of the source and the drain of the transistor 250 in FIG. 17C is electrically connected to the photosensor output signal line 214 and the other thereof is electrically connected to the gate of the transistor 205.

In FIGS. 17A to 17D, when the transistor 207 is formed using an oxide semiconductor to reduce off current, the charge stored in the gate of the transistor 205 can be held constant.

In FIGS. 17A to 17D, connection of the two electrodes of the photodiode 204 may be counterchanged depending on the circuit structure of the photosensor.

With the use of the above-described photodiode, the intensity of laser light, the period of pulsed laser light, and the like are read to input information to the information terminal.

### (Transistor)

There is no particular limitation on a semiconductor material used for the transistor. Silicon, a metal compound, or a metal oxide can be used.

There is no particular limitation on the crystallinity of a semiconductor material used for the transistors, and an amorphous semiconductor or a semiconductor having crystallinity (a microcrystalline semiconductor, a polycrystalline semiconductor, a single-crystal semiconductor, or a semiconductor partly including crystal regions) may be used. A semiconductor having crystallinity is preferably used, in which case deterioration of the transistor characteristics can be suppressed.

As a semiconductor material used for the transistors, a metal oxide whose energy gap is greater than or equal to 2 eV, preferably greater than or equal to 2.5 eV, further preferably greater than or equal to 3 eV can be used. A typical example thereof is an oxide containing indium, and for example, a CAC-OS described later or the like can be used. The metal oxide is referred to as an oxide semiconductor for its characteristics in some cases.

A transistor with a metal oxide having a larger band gap and a lower carrier density than silicon has a low off-state current; therefore, charges stored in a capacitor that is series-connected to the transistor can be held for a long time.

The semiconductor layer can be, for example, a film represented by an In-M-Zn-based oxide that contains indium, zinc, and M (a metal such as aluminum, titanium, gallium, germanium, yttrium, zirconium, lanthanum, cerium, tin, neodymium, or hafnium).

In the case where the metal oxide contained in the semiconductor layer contains an In-M-Zn-based oxide, it is preferable that the atomic ratio of metal elements of a sputtering target used for forming a film of the In-M-Zn oxide satisfy In M and Zn M. The atomic ratio of metal elements in such a sputtering target is preferably, for example, In:M:Zn=1:1:1, In:M:Zn=1:1:1.2, In:M:Zn=3:1:2, In:M:Zn=4:2:3, In:M:Zn=4:2:4.1, In:M:Zn=5:1:6, In:M:Zn=5:1:7, or In:M:Zn=5:1:8. Note that the atomic ratio of metal elements in the formed oxide semiconductor layer varies from the above atomic ratios of metal elements of the sputtering targets in a range of ±40%.

When a metal oxide, which can be formed at a lower temperature than polycrystalline silicon, is used for the semiconductor layer, materials with low heat resistance can be used as the material of a conductor, substrate, and insulating film below the semiconductor layer, so that the range of choices of materials can be widened. For example, an extremely large glass substrate can be used. As the insulating film, an inorganic insulating film such as a silicon oxide film or a silicon nitride film or a resin film such as acrylic or polyimide can be used. When such a material is used, the thickness of the insulating film can be less than or equal to 10 μm, preferably less than or equal to 5 μm, further preferably less than or equal to 2 μm, and the material cost can be reduced.

A metal oxide film with low carrier density is used as the semiconductor layer. For example, the semiconductor layer can include a metal oxide whose carrier density is lower than or equal to 1×10¹⁷/cm³, preferably lower than or equal to 1×10¹⁵/cm³, more preferably lower than or equal to 1×10¹³/cm³, still more preferably lower than or equal to 1×10¹¹/cm³, even more preferably lower than 1×10¹⁰/cm³, and higher than or equal to 1×10⁻⁹/cm³. Such a metal oxide is referred to as a highly purified intrinsic or substantially highly purified intrinsic metal oxide. The metal oxide has a low impurity concentration and a low density of defect states and can thus be referred to as a metal oxide having stable characteristics.

However, the composition is not limited to those described above, and a material having the appropriate composition may be used depending on required semiconductor characteristics and electrical characteristics of the transistor (e.g., field-effect mobility and threshold voltage). To obtain the required semiconductor characteristics of the transistor, it is preferable that the carrier density, the impurity concentration, the defect density, the atomic ratio between a metal element and oxygen, the interatomic distance, the density, and the like of the semiconductor layer be set to appropriate values.

When silicon or carbon that is one of elements belonging to Group 14 is contained in the metal oxide contained in the semiconductor layer, oxygen vacancies are increased in the semiconductor layer, and the semiconductor layer becomes n-type. Thus, the concentration of silicon or carbon (measured by secondary ion mass spectrometry) in the semiconductor layer is lower than or equal to 2×10¹⁸ atoms/cm³, preferably lower than or equal to 2×10¹⁷ atoms/cm³.

Alkali metal and alkaline earth metal might generate carriers when bonded to a metal oxide, in which case the off-state current of the transistor might be increased. Therefore, the concentration of alkali metal or alkaline earth metal of the semiconductor layer, which is measured by secondary ion mass spectrometry, is lower than or equal to 1×10¹⁸ atoms/cm³, preferably lower than or equal to 2×10¹⁶ atoms/cm³.

When nitrogen is contained in the metal oxide contained in the semiconductor layer, electrons serving as carriers are generated and the carrier density increases, so that the semiconductor layer easily becomes n-type. Thus, a transistor including a metal oxide that contains nitrogen is likely to be normally on. Hence, the concentration of nitrogen which is measured by secondary ion mass spectrometry is preferably set to lower than or equal to 5×10¹⁸ atoms/cm³.

The semiconductor layer may have a non-single-crystal structure, for example. The non-single-crystal structure includes CAAC-OS (c-axis aligned crystalline oxide semiconductor, or c-axis aligned a-b-plane-anchored crystalline oxide semiconductor) including a c-axis aligned crystal, a polycrystalline structure, a microcrystalline structure, or an amorphous structure, for example. Among the non-single crystal structures, the amorphous structure has the highest density of defect states, whereas CAAC-OS has the lowest density of defect states.

A metal oxide having an amorphous structure has disordered atomic arrangement and no crystalline component, for example. A metal oxide having an amorphous structure has, for example, an absolutely amorphous structure and no crystal part.

Note that the semiconductor layer may be a mixed film including two or more of the following: a region having an amorphous structure, a region having a microcrystalline structure, a region having a polycrystalline structure, a region of CAAC-OS, and a region having a single-crystal structure. The mixed film has, for example, a single-layer structure or a stacked-layer structure including two or more of the above regions in some cases.

### <Composition of CAC-OS>

Described below is the composition of a cloud-aligned composite oxide semiconductor (CAC-OS) applicable to a transistor disclosed in one embodiment of the present invention.

The CAC-OS has, for example, a composition in which elements included in a metal oxide are unevenly distributed. Materials including unevenly distributed elements each have a size of greater than or equal to 0.5 nm and less than or equal to 10 nm, preferably greater than or equal to 1 nm and less than or equal to 2 nm, or a similar size. Note that in the following description of a metal oxide, a state in which one or more metal elements are unevenly distributed and regions including the metal element(s) are mixed is referred to as a mosaic pattern or a patch-like pattern. The region has a size of greater than or equal to 0.5 nm and less than or equal to 10 nm, preferably greater than or equal to 1 nm and less than or equal to 2 nm, or a similar size.

Note that a metal oxide preferably contains at least indium. In particular, indium and zinc are preferably contained. In addition, one or more of aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0) or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite metal oxide with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to an element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≤x0≤1; m0 is a given number).

The above crystalline compounds have a single crystal structure, a polycrystalline structure, or a CAAC structure. Note that the CAAC structure is a crystal structure in which a plurality of IGZO nanocrystals have c-axis alignment and are connected in the a-b plane direction without alignment.

On the other hand, the CAC-OS relates to the material composition of a metal oxide. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected metal element(s) as a main component(s) are observed in part of the CAC-OS and nanoparticle regions including In as a main component are observed in part thereof, and these nanoparticle regions are randomly dispersed to form a mosaic pattern in the CAC-OS.

The CAC-OS can be formed by a sputtering method under conditions where a substrate is not intentionally heated, for example. In the case of forming the CAC-OS by a sputtering method, one or more selected from an inert gas (typically, argon), an oxygen gas, and a nitrogen gas may be used as a deposition gas. The ratio of the flow rate of an oxygen gas to the total flow rate of the deposition gas at the time of deposition is preferably as low as possible, and for example, the flow ratio of an oxygen gas is preferably higher than or equal to 0% and less than 30%, further preferably higher than or equal to 0% and less than or equal to 10%.

The CAC-OS is characterized in that no clear peak is observed in measurement using θ/2θ scan by an out-of-plane method, which is an X-ray diffraction (XRD) measurement method. That is, X-ray diffraction shows no alignment in the a-b plane direction and the c-axis direction in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring-like region are observed. Therefore, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image confirms that an In—Ga—Zn oxide with the CAC composition has a structure in which a region including GaO_{X3} as a main component and a region including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of a metal oxide is exhibited. Accordingly, when regions including In_{X2}Zn_{Y2}O_{Z2} or InO_{X1} as a main component are distributed in a metal oxide like a cloud, high field-effect mobility (μ) can be achieved.

By contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in a metal oxide, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby a high on-state current (Ion) and high field-effect mobility (μ) can be achieved.

A semiconductor element including a CAC-OS has high reliability. Thus, the CAC-OS is suitably used in a variety of semiconductor devices typified by a display.

Alternatively, silicon may be used as a semiconductor in which a channel of a transistor is formed. Silicon may be amorphous silicon but is preferably silicon having crystallinity, such as microcrystalline silicon, polycrystalline silicon, or single crystal silicon. In particular, polycrystalline silicon can be formed at a lower temperature than single crystal silicon and has higher field-effect mobility and higher reliability than amorphous silicon. The use of such a polycrystalline semiconductor in pixels increases the aperture ratio of the pixels.

The bottom-gate transistor using silicon as a semiconductor is preferable because the number of manufacturing steps can be reduced. When amorphous silicon is used, the transistor can be formed at a lower temperature than polycrystalline silicon. Thus, materials with low heat resistance can be used as materials of a wiring, an electrode, or a substrate below the semiconductor layer, resulting in wider choice of materials. For example, an extremely large glass substrate can be favorably used. Meanwhile, the below-described top-gate transistor is preferable because an impurity region is easily formed in a self-aligned manner and variation in characteristics can be reduced. In that case, the use of polycrystalline silicon, single-crystal silicon, or the like is particularly preferable.

This embodiment can be implemented in combination with any other embodiment as appropriate.

### Embodiment 3

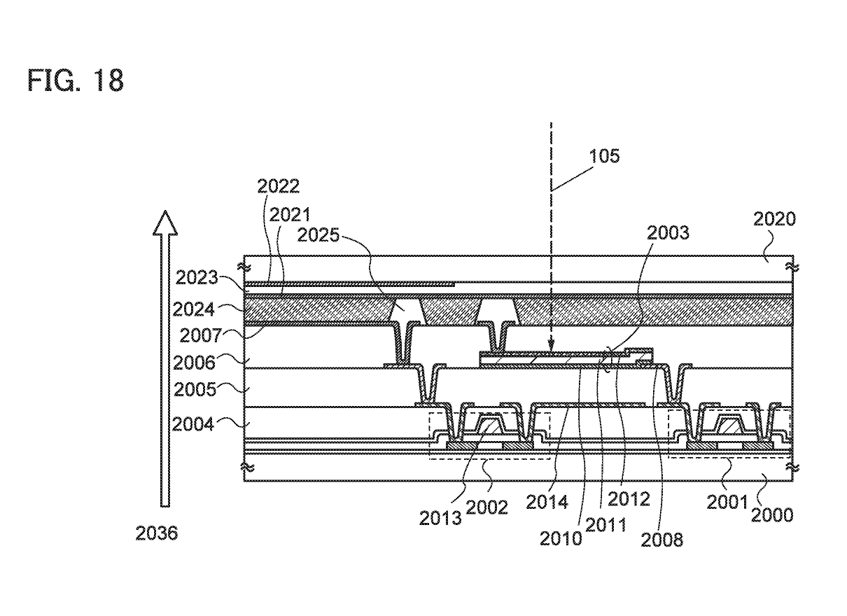

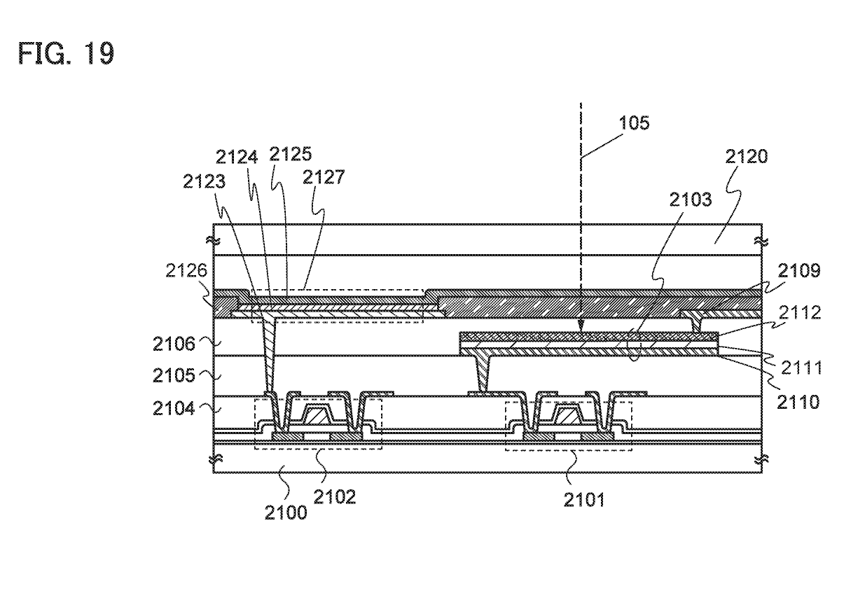

In this embodiment, a structure of a display portion of an information terminal that can be used as the present invention will be described with reference to FIG. 18 and FIG. 19. In this embodiment, the display portion includes a photosensor and a display element. The display element is a liquid crystal element in FIG. 18. The display element is a light-emitting element in FIG. 19.

### (Liquid Crystal Element)

FIG. 18 illustrates an example of a cross section of a liquid crystal display device including a liquid crystal element as the display element. A photosensor 2003 is irradiated with the laser light 105 from an input unit.

As a substrate 2000, a light-transmitting substrate such as a glass substrate or a quartz substrate is used. A thin film transistor 2001, a thin film transistor 2002, and the photosensor 2003 are provided on the substrate 2000. The photosensor 2003 is formed by stacking an n-type semiconductor layer 2010, an i-type semiconductor layer 2011, and a p-type semiconductor layer 2012 in that order. The n-type semiconductor layer 2010 contains an impurity element imparting one conductivity type (e.g., phosphorus). The i-type semiconductor layer 2011 is an intrinsic semiconductor. The p-type semiconductor layer 2012 contains an impurity element imparting another one conductivity type (e.g., boron).

In FIG. 18, top gate thin film transistors are used as the thin film transistors 2001 and 2002; however, this embodiment is not limited to this. As the thin film transistors 2001 and 2002, bottom gate thin film transistors can also be used. Further, the photosensor 2003 has a structure where the n-type semiconductor layer 2010, the i-type semiconductor layer 2011, and the p-type semiconductor layer 2012 are provided; however, this embodiment is not limited to this.

In this embodiment, a crystalline semiconductor layer can be used as each semiconductor layer included in the thin film transistors 2001 and 2002. For example, polycrystalline silicon can be used; however, the present invention is not limited to this. Amorphous silicon, microcrystalline silicon, and single crystal silicon; an organic semiconductor such as pentacene, an oxide semiconductor, or the like may be used as semiconductor layers included in the thin film transistors 2001 and 2002. In order to form a semiconductor layer of single crystal silicon over the substrate 2000, the substrate 2000 is bonded to a single crystal silicon substrate in which a damaged region is provided at a predetermined depth from the surface, and the single crystal silicon substrate is separated at the damaged region to be provided over the substrate 2000. As the oxide semiconductor, a composite oxide of an element selected from indium, gallium, aluminum, zinc, tin, or the like can be used.

An insulating layer 2004 is provided so as to cover the thin film transistors 2001 and 2002. An insulating layer 2005 is provided over the insulating layer 2004, and an insulating layer 2006 is provided over the insulating layer 2005. A pixel electrode 2007 is provided over the insulating layer 2006, and the photosensor 2003 and a lower electrode 2008 are provided over the insulating layer 2005. Owing to the lower electrode 2008, the photosensor 2003 and the thin film transistor 2001 are electrically connected to each other through an opening portion provided in the insulating layer 2005.

In addition, a counter substrate 2020 is provided with a counter electrode 2021, a color filter layer 2022, and an overcoat layer 2023. The counter substrate 2020 and the substrate 2000 are fixed to each other with a sealant, and the substrates are kept at an substantially or exactly constant distance by a spacer 2025. A liquid crystal layer 2024 is sandwiched between the pixel electrode 2007 and the counter electrode 2021, whereby a liquid crystal element is formed.

Note that although the color filter layer 2022 is provided to overlap with the pixel electrode 2007 and does not overlap with the photosensor 2003 in FIG. 18, this embodiment is not limited thereto and the color filter layer 2022 may overlap with the photosensor 2003.

The photosensor 2003 overlaps with a gate electrode 2013 of the thin film transistor 2002 as illustrated in FIG. 18 and is preferably provided so as to overlap with also a signal line 2014 of the thin film transistor 2002.

A backlight is provided for a liquid crystal display device of this embodiment. In FIG. 18, the backlight is provided on the substrate 2000 side, and light is emitted in a direction indicated by an arrow 2036. As the backlight, a cold cathode fluorescent lamp (CCFL) or a white light-emitting diode can be used. A white light-emitting diode is preferable because the adjustable range of luminance is wider than that of a cold-cathode fluorescent lamp.

The sensitivity of the photosensor 2003 can be adjusted in accordance with the usage environment by providing the photosensor 2003, for example, also in a driver circuit portion, for detecting external light.

A backlight is not limited to the above structure. For example, light-emitting diodes (LEDs) of RGB may be used to form a backlight, or color display may be performed in a field sequential method with sequentially lighting of LED backlights of RGB. A color filter layer is not necessary in that case.

The photosensor 2003 may function as a touch sensor in addition to a function of detecting laser light. For example, when a user's finger or a touch pen such as a stylus touches the counter substrate 2020, light from the backlight is reflected by the finger or the touch pen. The reflected light enters the photosensor 2003, so that the photosensor 2003 detects the touch. Note that the finger or touch pen does not necessarily directly touch the counter substrate 2020. The photosensor 2003 may detect the finger or touch pen near the counter substrate 2020.

Here, an example of the method for manufacturing the liquid crystal display device illustrated in FIG. 18 is briefly described.

First, top gate thin film transistors each including a crystalline semiconductor layer as an active layer are formed. Here, the thin film transistor 2002 including the gate electrode 2013 and the thin film transistor 2001 which is electrically connected to the photosensor 2003 are formed over the same substrate. An n-type thin film transistor or a p-type thin film transistor can be used as each transistor. Further, a storage capacitor can be formed through the similar steps to these transistors. Note that the storage capacitor may use the semiconductor layer as a lower electrode and a capacitor wiring as an upper electrode, and an insulating film which is formed in the same step to a gate insulating film of the thin film transistor 2001 and the thin film transistor 2002 as a dielectric.

Further, contact holes are formed in the insulating layer 2004, which is one of interlayer insulating layers of the thin film transistors, and a source electrode and a drain electrode which are electrically connected to the semiconductor layer of each of the thin film transistors or a connection electrode which is electrically connected to an upper wiring is formed. Moreover, a signal line of the thin film transistor 2001, which is electrically connected to the photosensor 2003, is formed in the similar steps. Further, the signal line 2014 of the thin film transistor 2002 is also formed in the similar steps.

Next, the insulating layer 2005 which covers the signal line 2014 is formed. Note that in this embodiment, since a transmissive liquid crystal display device is shown as an example, the insulating layer 2005 is formed of an insulating material through which visible light can pass. Then, a contact hole is formed in the insulating layer 2005, and the lower electrode 2008 is formed over the insulating layer 2005.

Then, the photosensor 2003 is formed so as to overlap with at least part of the lower electrode 2008. The lower electrode 2008 is an electrode for electrically connecting the photosensor 2003 and the thin film transistor 2001. The photosensor 2003 is formed by stacking the n-type semiconductor layer 2010, the i-type semiconductor layer 2011, and the p-type semiconductor layer 2012 in that order. In this embodiment, microcrystalline silicon containing phosphorus, amorphous silicon, and microcrystalline silicon containing boron are stacked as the n-type semiconductor layer 2010, the i-type semiconductor layer 2011, and the p-type semiconductor layer 2012, respectively, by a plasma CVD method.

Next, the insulating layer 2006 which covers the photosensor 2003 is formed. In the case of a transmissive liquid crystal display device, the insulating layer 2006 is formed of an insulating material through which visible light can pass. Then, a contact hole is formed in the insulating layer 2006, and the pixel electrode 2007 is formed over the insulating layer 2006. A wiring is formed using the same layer as the pixel electrode 2007. The wiring is electrically connected to the p-type semiconductor layer 2012, which is an upper electrode of the photosensor 2003.

Next, the spacer 2025 is formed over the insulating layer 2006. Although a columnar spacer (a post spacer) is provided as the spacer 2025 in FIG. 18, a spherical spacer (a bead spacer) may be alternatively used.

Then, when a TN liquid crystal or the like is used as the liquid crystal layer 2024, an alignment film is formed over the pixel electrode 2007 by coating, and rubbing treatment is performed thereon.

Meanwhile, the color filter layer 2022, the overcoat layer 2023, and the counter electrode 2021 are formed over the counter substrate 2020. Then, an alignment film is formed over the counter electrode 2021 by coating, and rubbing treatment is performed thereon.

After that, a surface of the substrate 2000, over which the alignment film is formed by coating, and a surface of the counter substrate 2020, over which the alignment film is formed by coating, are attached to each other with a sealant. A liquid crystal is placed between these substrates by a liquid crystal dropping method or a liquid crystal injection method, whereby the liquid crystal layer 2024 is formed.

Note that a liquid crystal exhibiting a blue phase for which an alignment film is not necessary may be used for the liquid crystal layer 2024. A blue phase is one of liquid crystal phases, which is generated just before a cholesteric phase changes into an isotropic phase while temperature of a cholesteric liquid crystal is increased. Since the blue phase appears only in a narrow temperature range, in order to use the blue phase liquid crystal in the liquid crystal layer 2024, a chiral material is mixed into the blue phase liquid crystal composition at 5 wt. % or more to broaden the temperature range. As for the liquid crystal composition which contains a liquid crystal exhibiting a blue phase and a chiral material, the response speed is as high as 10 μs or more and 100 μs or less, alignment treatment is not necessary due to optical isotropy, and viewing angle dependence is low.

### (Light-Emitting Element)

Next, an electroluminescent display device (hereinafter referred to as an “EL display device”) which has a light-emitting element as a display element will be described.

FIG. 19 illustrates an example of the cross-sectional view of an EL display element using an EL element (for example, an organic EL element, an inorganic EL element, or an EL element including an organic substance and an inorganic substance) as a light-emitting element in the display device. A state in which the photosensor 2103 is irradiated with the laser light 105 from the input unit.

In FIG. 19, a thin film transistor 2101, a thin film transistor 2102, and the photosensor 2103 are provided over a substrate 2100. The photosensor 2103 is formed by stacking an n-type semiconductor layer 2110, an i-type semiconductor layer 2111, and a p-type semiconductor layer 2112. The substrate 2100 is fixed to a counter substrate 2120 by a sealant.

An insulating layer 2104 is provided so as to cover the thin film transistors 2101 and 2102. An insulating layer 2105 is provided over the insulating layer 2104, and an insulating layer 2106 is provided over the insulating layer 2105. The EL element 2127 is provided over the insulating layer 2106, and the photosensor 2103 is provided over the insulating layer 2105. The photosensor 2103 and the thin film transistor 2101 are electrically connected to each other using the n-type semiconductor layer 2110 of the photosensor 2103 through an opening provided in the insulating layer 2105.

Further, a sensor wiring 2109 electrically connects the p-type semiconductor layer 2112 and another wiring.

The EL element 2127 is formed by stacking a pixel electrode 2123, a light-emitting layer 2124, and a counter electrode 2125 in that order. Note that light-emitting layers of adjacent pixels are divided by a bank 2126.

Either an n-type thin film transistor or a p-type thin film transistor can be used as each of the thin film transistor 2101 and the thin film transistor 2102. In the case where the pixel electrode 2123 functions as a cathode, the thin film transistor 2102 which is electrically connected to the pixel electrode 2123 is preferably an n-type thin film transistor in considering the direction of current. Further, in the case where the pixel electrode 2123 functions as an anode, the thin film transistor 2102 is preferably a p-type thin film transistor.

The photosensor 2103 may function as a touch sensor in addition to a function of detecting laser light. For example, when a user's finger or a touch pen such as a stylus touches the counter substrate 2120, light from the EL element 2127 is reflected by the finger or the touch pen. The reflected light enters the photosensor 2103, so that the photosensor 2103 detects the touch. Note that the finger or touch pen does not necessarily directly touch the counter substrate 2120. The photosensor 2103 may detect the finger or touch pen near the counter substrate 2120.

### Modification Example of Display Element

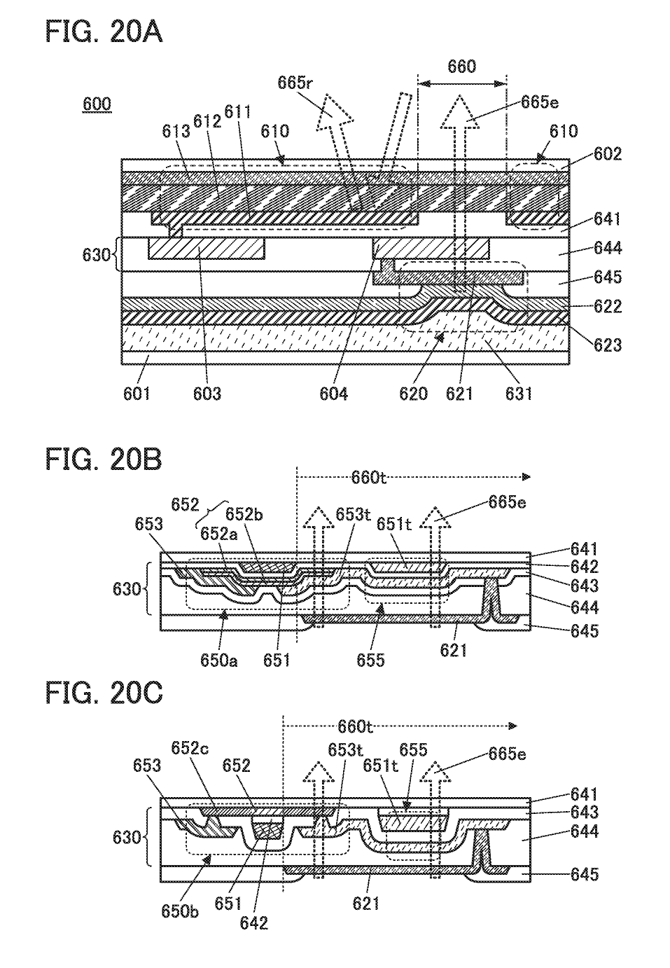

FIGS. 20A to 20C illustrate examples of a display device 600 of one embodiment of the present invention. The display device 600 is a hybrid display including a self-luminous display element and a display element utilizing external light to achieve hybrid display.

Hybrid display is a method for displaying a letter or an image using reflected light and self-emitted light together in one panel that complement the color tone or light intensity of each other. Alternatively, hybrid display is a method for displaying a letter and/or an image using light from a plurality of display elements in one pixel or one subpixel. Note that when a hybrid display is locally observed, a pixel or a subpixel performing display using any one of the plurality of display elements and a pixel or a subpixel performing display using two or more of the plurality of display elements are included in some cases.

Note that in the present specification and the like, hybrid display satisfies any one or a plurality of the above-described descriptions.

Furthermore, a hybrid display includes a plurality of display elements in one pixel or one subpixel. Note that as an example of the plurality of display elements, a reflective element that reflects light and a self-luminous element that emits light can be given. Note that the reflective element and the self-luminous element can be controlled independently. A hybrid display has a function of displaying a letter and/or an image using one or both of reflected light and self-emitted light in a display portion.

A display device in which a light-emitting element is provided as a self-luminous display element and a reflective liquid crystal element is provided as a display element utilizing external light is described. The aperture ratio of the display device can be increased because a light-transmitting material is used for a circuit positioned on an optical path of light from the light-emitting element.

FIG. 20A is a schematic cross-sectional view of the display device 600. The display device 600 includes a liquid crystal element 610, a light-emitting element 620, and a functional layer 630 between a substrate 601 and a substrate 602. The liquid crystal element 610 is a reflective liquid crystal element that reflects light on the substrate 602 side. The light-emitting element 620 emits light to the substrate 602 side. The functional layer 630 includes a circuit 603 for driving the liquid crystal element 610, a circuit 604 for driving the light-emitting element 620, a photosensor, and the like. Since the functional layer 630 is provided, the liquid crystal element 610 and the light-emitting element 620 can be individually driven.

The liquid crystal element 610 includes an electrode 611, a liquid crystal layer 612, and an electrode 613. The electrode 613 provided on the substrate 602 side transmits visible light and is supplied with a common potential. The electrode 611 provided on the functional layer 630 side reflects visible light and serves as a pixel electrode. The electrode 611 is electrically connected to the circuit 603 through an opening provided in the insulating layer 641. Although not illustrated here, a circularly polarizing plate is provided outward from the substrate 602.

Reflected light 665r emitted from the liquid crystal element 610 is light reflected by the electrode 611 among light incident from the substrate 602 side. Note that a color filter may be provided on the optical path of the reflected light 665r.

The light-emitting element 620 includes an electrode 621, a layer 622 containing a light-emitting substance, and an electrode 623 in this order from the functional layer 630 side. The electrode 621 transmits visible light and serves as a pixel electrode. The electrode 623 reflects visible light and is supplied with a common potential. The electrode 621 is electrically connected to the circuit 604 through an opening provided in the insulating layer 644. An insulating layer 645 is preferably provided to cover the end portion of the electrode 621. The light-emitting element 620 is sealed with a sealing layer 631 and the substrate 601.

The circuit 603 and the circuit 604 can each include an electrical element such as a switch, a transistor, a capacitor, or a resistor, for example. Wirings connecting them may be included.

As the transistor, the capacitor, and the other components used in the circuit 603 and the circuit 604, the components used in the other embodiments can be used.

Light 665e from the light-emitting element 620 is emitted to the substrate 602 side across a region where the electrode 611 of the liquid crystal element 610 is not provided. Note that a color filter may be provided on the optical path of the light 665e.

A region 660 illustrated in FIG. 20A is a region which is not provided with the electrode 611 that reflects visible light, with which the light-emitting element 620 overlaps, and through which the light 665e emitted from the light-emitting element 620 passes. The region 660 may be a portion overlapping with the opening provided in the electrode 611, or may be a portion overlapping with a slit or a shaft in the electrode. In addition, the region 660 may be a region positioned between two electrodes 611 provided in two adjacent pixels.

In FIG. 20A, part of the circuit 604 included in the functional layer 630 is provided to overlap with the region 660. Note that part of the circuit 603 may be provided to overlap with the region 660. The circuit 603 or the circuit 604 preferably includes a member that transmits visible light at least in the portion overlapping with the light-emitting element 620. Thus, the light 665e can pass through the circuit 603 or the circuit 604 to be emitted to the substrate 602 side.

Materials described below can be used for the transistors, wirings, capacitors, and the like included in the functional layer 630.

The semiconductor layer included in the transistor can be formed using a light-transmitting semiconductor material. Examples of the light-transmitting semiconductor material include a metal oxide and an oxide semiconductor. An oxide semiconductor preferably contains at least indium. In particular, indium and zinc are preferably contained. In addition, aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

A wiring, an electrode included in the transistor or capacitor, or the like can be formed using a light-transmitting conductive material. The light-transmitting conductive material preferably contains one or more kinds of indium, zinc, and tin. Specifically, an In oxide, an In—Sn oxide, an In—Zn oxide, an In—W oxide, an In—W—Zn oxide, an In—Ti oxide, an In—Sn—Ti oxide, an In—Sn—Si oxide, a Zn oxide, a Ga—Zn oxide, or the like can be used.

A wiring, an electrode included in the transistor, the capacitor, or the like may be formed using an oxide semiconductor containing an impurity element to be reduced in resistance. The oxide semiconductor to be reduced in resistance can be referred to as oxide conductor.

For example, to form an oxide conductor, oxygen vacancies are formed in an oxide semiconductor and then hydrogen is added to the oxygen vacancies, so that a donor level is formed in the vicinity of the conduction band. The oxide semiconductor having the donor level has an increased conductivity and becomes a conductor.

An oxide semiconductor has a large energy gap (e.g., an energy gap of 2.5 eV or larger), and thus has a visible light transmitting property. An oxide conductor is an oxide semiconductor having a donor level in the vicinity of the conduction band, as described above. Therefore, the influence of absorption due to the donor level is small in an oxide conductor, and an oxide conductor has a visible light transmitting property comparable to that of an oxide semiconductor.

The oxide conductor preferably includes one or more kinds of metal elements included in the semiconductor film of the transistor. When two or more layers included in the transistor are formed using the oxide semiconductors including the same metal element, the same manufacturing apparatus (e.g., deposition apparatus or processing apparatus) can be used in two or more steps and manufacturing cost can thus be reduced.

The structure of the pixel in the display device described in this embodiment enables efficient use of light emitted from the light-emitting element. Thus, the excellent display device with reduced power consumption can be provided.

FIG. 20B is a schematic cross-sectional view of a structure example of the functional layer 630 that can be used for the circuit 604 in FIG. 20A.

FIG. 20B illustrates a transistor 650a, a capacitor 655, and the electrode 621. The transistor 650a is a bottom-gate transistor.

The transistor 650a includes a conductive layer 651 functioning as a gate electrode, an insulating layer 642 covering the conductive layer 651 and partly serving as a gate insulating layer, a semiconductor layer 652 covering part of the insulating layer 642, and conductive layers 653 and 653t which are in contact with the semiconductor layer 652 and serve as a source electrode and a drain electrode. The capacitor 655 includes part of the conductive layer 653t, part of the insulating layer 642, and a conductive layer 651t. The electrode 621 is electrically connected to the conductive layer 653t through an opening provided in the insulating layer 644 and the insulating layer 643.

Note that in the case where a photosensor is provided between the transistor 650a and the electrode 621, one or more insulating layers are provided between the insulating layer 643 and the insulating layer 644 or between the insulating layer 644 and the electrode 621 in some cases.

Here, the conductive layers 651t and 653t, the electrode 621, and the like are each preferably formed using a conductive material having a light-transmitting property with respect to visible light. It is particularly preferable to use a metal oxide.

A metal oxide exhibiting semiconductor characteristics (also referred to as oxide semiconductor: OS) is preferably used for the semiconductor layer 652. Furthermore, the semiconductor layer 652 preferably includes a pair of low-resistance regions between which the channel formation region is sandwiched. The low-resistance regions have higher conductivity than the channel formation region and can also be referred to as oxide conductor (OC).

FIG. 20B illustrates an example in which the semiconductor layer 652 has a stacked-layer structure of a semiconductor layer 652a and a semiconductor layer 652b in this order from the conductive layer 651 side. Note that the structure of the semiconductor layer 652 is not limited thereto, and the semiconductor layer 652 may have a single-layer structure of the semiconductor layer 652a or 652b or a stacked-layer structure of three or more layers. For example, when the semiconductor layer 652 has a three-layer structure, a stacked-layer structure in which the semiconductor layer 652a is sandwiched between a pair of semiconductor layers 652b can be employed.

The semiconductor layer 652b and the semiconductor layer 652a preferably contain In, M (M is Ga, Al, Y, or Sn), and Zn. The semiconductor layers 652a and 652b preferably include regions in which the atomic proportion of In is larger than the atomic proportion of M, because the field-effect mobility of the transistor can be increased. For example, the atomic ratio of In to M and Zn of the oxide semiconductor films included in the semiconductor layers 652b and 652a is preferably In:M:Zn=4:2:3 or a neighborhood of In:M:Zn=4:2:3, or In:M:Zn=5:1:7 or a neighborhood of In:M:Zn=5:1:7.

For the semiconductor layers 652b and 652a, it is particularly preferable to use semiconductor films deposited successively without exposure to the air using targets with the same composition, although it is also possible to use films deposited using targets with different compositions. In that case, the process can be performed in one deposition apparatus, and moreover, impurity residues between the semiconductor layer 652a and the semiconductor layer 652b can be reduced.

Here, for example, the semiconductor layer 652b preferably includes a region with a higher crystallinity than the semiconductor layer 652a. Thus, the semiconductor layer 652b can have excellent resistance to etching than the semiconductor layer 652a. Therefore, when the conductive layer 653 and the conductive layer 653t are processed, the semiconductor layer 652b can be prevented from being lost by the etching. As a result, a channel-etched transistor as illustrated in FIG. 20B can be formed. Furthermore, when a high-crystallinity film is used for the semiconductor layer 652b positioned on the back channel side of the transistor 650a, the amount of impurities which may diffuse into the semiconductor layer 652a positioned on the gate electrode side can be reduced. Thus, the transistor 650a can have high reliability.

When the semiconductor layer 652a is formed using a film including a lower-crystallinity region than the semiconductor layer 652b, oxygen is easily diffused into the semiconductor layer 652a and the semiconductor layer 652a can have a low proportion of oxygen vacancies. In particular, the semiconductor layer 652a is positioned close to the gate electrode and is a main layer where a channel is easily formed. Thus, when such a film is used, a highly reliable transistor can be obtained.

The semiconductor layers 652a and 652b can be formed separately in different conditions, for example. For example, the flow rates of oxygen gas in the deposition gases can be different between the semiconductor layers 652a and 652b.

In this case, as the deposition condition of the semiconductor layer 652a, the proportion of oxygen gas flow rate (also referred to as oxygen flow rate ratio) in a whole deposition gas is higher than or equal to 0% and lower than or equal to 30%, preferably higher than or equal to 5% and lower than or equal to 15%. With the oxygen flow rate ratio in the above range, the semiconductor layer 652a can have low crystallinity.

As the deposition condition of the semiconductor layer 652b, the oxygen flow rate ratio is higher than 30% and lower than or equal to 100%, preferably higher than or equal to 50% and lower than or equal to 100%, further preferably higher than or equal to 70% and lower than or equal to 100%. With the oxygen flow rate ratio in the above range, the semiconductor layer 652b can have high crystallinity.

The substrate temperature at the time of forming the semiconductor layers 652a and 652b is set higher than or equal to room temperature (25° C.) and lower than or equal to 200° C., preferably higher than or equal to room temperature and lower than or equal to 130° C. The substrate temperature in the range can prevent bending or warpage of the substrate in the case where the substrate is a large glass substrate. Here, when the semiconductor layer 652a and the semiconductor layer 652b are formed at the same substrate temperature, the productivity can be increased. When the substrate temperature is different between the semiconductor layer 652a and the semiconductor layer 652b, the deposition temperature of the semiconductor layer 652b is increased, for example, so that the crystallinity of the semiconductor layer 652b can be further increased.

A conductive material that blocks visible light is preferably used for the conductive layer 651 functioning as the gate electrode of the transistor 650a. This can prevent a channel formation region of the semiconductor layer 652 from being irradiated with light, thereby suppressing change in the electrical characteristics of the transistor 650a. At this time, part of a gate line (also referred to as scan line) is preferably used as the conductive layer 651.

A conductive material blocking visible light may be used for the conductive layer 653 functioning as the source electrode and the drain electrode of the transistor 650a. At this time, part of a source line (also referred to as signal line) is preferably used as the conductive layer 653.

In FIG. 20B, a region including part of the transistor 650a, the capacitor 655, a contact portion of the conductive layer 653t and the electrode 621, and the like can be collectively used as a transmissive region 660t.

FIG. 20C illustrates an example in which a top-gate transistor 650b is used.

In the transistor 650b, the insulating layer 642 and the conductive layer 651 are stacked to cover the semiconductor layer 652, the insulating layer 643 is provided to cover the conductive layer 651, and the conductive layer 653 and the conductive layer 653t are provided to cover part of the insulating layer 643. The capacitor 655 includes the conductive layer 651t, the conductive layer 653t, and the insulating layer 643.

Note that in the case where a photosensor is provided between the transistor 650b and the electrode 621, one or more insulating layers are provided between the insulating layer 643 and the insulating layer 644 or between the insulating layer 644 and the electrode 621 in some cases.

The semiconductor layer 652 may have a structure similar to that of either one or both of the semiconductor layers 652a and 652b. The semiconductor layer 652 may have a single-layer structure or a stacked-layer structure of three or more layers.

FIG. 20C illustrates a pair of low-resistance regions 652c between which the channel formation region of the semiconductor layer 652 is sandwiched. The low-resistance regions 652c can have higher carrier concentration or higher impurity concentration than the channel formation region. In the case where an oxide semiconductor (OS) is used for the semiconductor layer 652, the low-resistance regions 652c can each be referred to as an oxide conductor (OC).

Note that the low-resistance region 652c is a n-type region of the semiconductor layer 652. The low-resistance region 652c is in contact with the insulating layer 643 and the insulating layer 643 contains nitrogen or hydrogen. Therefore, nitrogen or hydrogen in the insulating layer 643 enters the low-resistance region 652c, whereby the carrier concentration in the semiconductor layer 652 can be increased. Note that the low-resistance region 652c is not limited thereto, and may be formed by adding impurities using the conductive layer 651 as a mask. Examples of the impurity include hydrogen, helium, neon, argon, fluorine, nitrogen, phosphorus, arsenic, antimony, boron, aluminum, and the like. The addition of the impurities can be performed by an ion implantation method or an ion doping method. Other than the above impurities, for example, indium, which is a constituent element of the semiconductor layer 652, may be added to form the low-resistance regions 652c. When indium is added to the low-resistance regions 652c, the concentration of indium in the low-resistance regions 652c is higher than that in the channel formation region in some cases.

After the addition of the impurity, heat treatment may be performed (typically at higher than or equal to 100° C. and lower than or equal to 400° C., preferably at higher than or equal to 150° C. and lower than or equal to 350° C.).

The addition of the impurity can be applied to another oxide conductor (OC) as well as the low-resistance regions 652c.

Note that in the case where silicon, typically amorphous silicon, low-temperature polysilicon, or the like is used for the semiconductor layer 652 of the transistor 650b, the aforementioned low-resistance region 652c corresponds to a region that contains silicon containing an impurity such as phosphorus or boron. Silicon has a band gap of approximately 1.1 eV. Thus, in the case where silicon is used for the semiconductor layer of the transistor, the semiconductor layer absorbs part of visible light, which makes it difficult to extract light through the semiconductor layer. The light-transmitting property might be further reduced when silicon contains an impurity such as phosphorus or boron. Hence, it is sometimes more difficult to extract light through the low-resistance region formed in silicon. However, since the oxide semiconductor (OS) and the oxide conductor (OC) transmit visible light in one embodiment of the present invention, the aperture ratio of the light-emitting element in the pixel or the subpixel can be improved.

As described above, the use of a material that transmits visible light for the conductive layers, the semiconductor layer, and the like which are positioned on the optical path of the light-emitting element 620 can increase the effective light-emitting area of the light-emitting element 620. The use of a low-resistance material having a light-blocking property for the wirings such as a source line, a gate line, or a potential supply line (also referred to as bus lines) can reduce parasitic resistance.

This embodiment can be combined with any of the other embodiments as appropriate.

### Embodiment 4

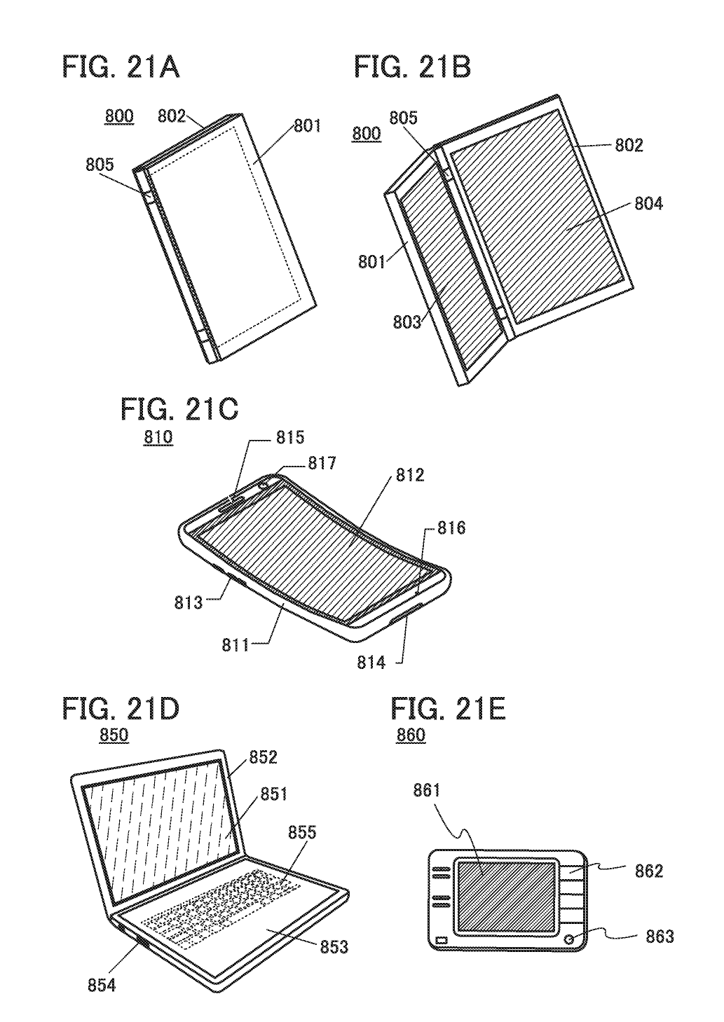

In this embodiment, electronic devices that can be applied to the information terminal of one embodiment of the present invention are described with reference to FIGS. 21A and 21B, FIGS. 22A and 22B, and FIGS. 23A and 23B.

FIGS. 21A and 21B illustrate examples of a portable information terminal. A portable information terminal 800 illustrated in FIGS. 21A and 21B can be used as a tablet computer or an e-book reader. The portable information terminal 800 includes a housing 801, a housing 802, a display portion 803, a display portion 804, and a hinge 805, for example.

The housing 801 and the housing 802 are joined together with the hinge 805. The portable information terminal 800 folded as illustrated in FIG. 21A can be changed into the state illustrated in FIG. 21B, in which the housing 801 and the housing 802 are opened.

For example, text information can be displayed on the display portions 803 and 804; thus, the portable information terminal can be used as an e-book reader. Furthermore, still images and moving images can be displayed on the display portions 803 and 804.

The portable information terminal 800 can be folded when being carried, and thus has general versatility.

Note that the housings 801 and 802 may have a power button, an operation button, an external connection port, a speaker, a microphone, and the like.

The photosensor described in the above embodiment is provided for at least one of the display portion 803 and the display portion 804.

FIG. 21C illustrates an example of a portable information terminal. A portable information terminal 810 illustrated in FIG. 21C includes a housing 811, a display portion 812, an operation button 813, an external connection port 814, a speaker 815, a microphone 816, a camera 817, and the like.

The photosensor described in the above embodiment is provided in the display portion 812.

In the portable information terminal 810, information can be input using the display portion 812 to make a call and input a text.

With the operation buttons 813, power on/off can be switched and types of images displayed on the display portion 812 can be switched. For example, a mail preparation screen can be switched to a main menu screen.

When a detection device such as a gyroscope sensor or an acceleration sensor is provided inside the portable information terminal 810, the direction of display on the screen of the display portion 812 can be automatically changed by determining the orientation of the portable information terminal 810 (whether the portable information terminal 810 is placed horizontally or vertically). The direction of display on the screen can also be changed by touch on the display portion 812, operation with the operation buttons 813, sound input using the microphone 816, or the like.

The portable information terminal 810 has one or more of a telephone function, a notebook function, an information browsing function, and the like. Specifically, the portable information terminal can be used as a smartphone. The portable information terminal 810 is capable of executing a variety of applications such as mobile phone calls, e-mailing, viewing and editing texts, music reproduction, video replay, Internet communication, and games.

FIG. 21D illustrates a laptop computer 850. The computer 850 includes a display portion 851, a housing 852, a touch pad 853, a connection port 854, and the like.

The touch pad 853 functions as an input unit such as a pointing device or a pen tablet and can be controlled with a finger, a stylus, or the like.

Furthermore, a display element is incorporated in the touch pad 853. As illustrated in FIG. 21D, when an input key 855 is displayed on a surface of the touch pad 853, the touch pad 853 can be used as a keyboard. In that case, a vibration module may be incorporated in the touch pad 853 so that sense of touch is achieved by vibration when a user touches the input key 855.

The photosensor described in the above embodiment is provided for at least one of the display portion 851 and the touch pad 853. Note that instead of the touch pad 853, a known keyboard may be provided.

FIG. 21E illustrates a navigation device 860. The navigation device illustrated in FIG. 21E includes a display portion 861, operation buttons 862, and an external input terminal 863.

The photosensor described in the above embodiment is provided in the display portion 861.

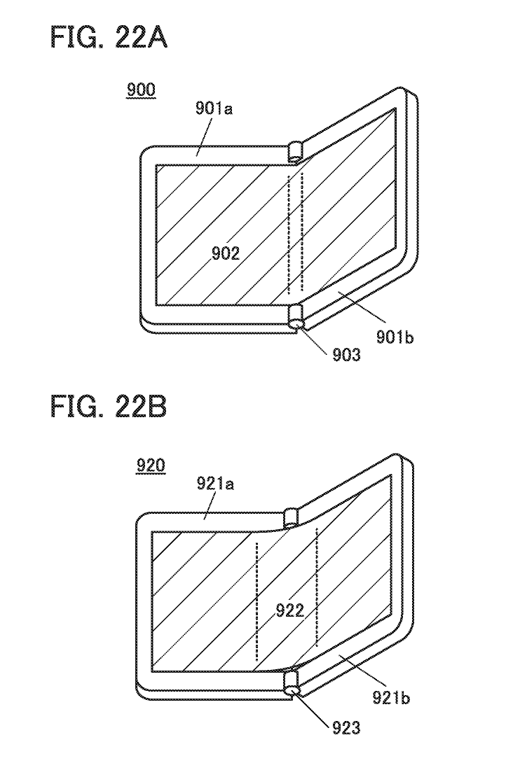

FIGS. 22A and 22B illustrate foldable electronic devices.

An electronic device 900 illustrated in FIG. 22A includes a housing 901a, a housing 901b, a hinge 903, a display portion 902, and the like. The display portion 902 is incorporated into the housing 901a and the housing 901b.

The housing 901a and the housing 901b are rotatably joined to each other by the hinge 903. The electronic device 900 can be changed in shape between a state where the housing 901a and the housing 901b are closed and a state where the housing 901a and the housing 901b are opened as illustrated in FIG. 22A. Thus, the electronic device 900 has high portability when carried and excellent visibility when used because of its large display region.

The hinge 903 preferably includes a locking mechanism so that an angle formed between the housing 901a and the housing 901b does not become larger than a predetermined angle when the housing 901a and the housing 901b are opened. For example, an angle at which they become locked (they are not opened any further) is preferably greater than or equal to 90° and less than 180° and can be typically 90°, 120°, 135°, 150°, 175°, or the like. In that case, the convenience, the safety, and the reliability can be improved.

The photosensor described in the above embodiment is provided in the display portion 902.

Either of the housing 901a and the housing 901b is provided with a wireless communication module, and data can be transmitted and received through a computer network such as the Internet, a local area network (LAN), or Wireless Fidelity (Wi-Fi: registered trademark).

The display portion 902 is preferably formed using one flexible display, in which case an image can be displayed continuously between the housing 901a and the housing 901b. Note that each of the housings 901a and 901b may be provided with a display. It is preferable that in the state where the electronic device 900 is opened such that the housing 901a and the housing 901b are exposed, part of the flexible display included in the display portion 902 be held while being curved. Note that each of the housing 901a and the housing 901b may be provided with a display.

In an electronic device 920 illustrated in FIG. 22B, a flexible display portion 922 is provided across a housing 921a and a housing 921b which are joined to each other by a hinge 923.

In FIG. 22B, the display portion 922 is greatly curved with the housing 921a and the housing 921b open. For example, the display portion 922 is held with a curvature radius of 1 mm or greater and 50 mm or less, preferably 5 mm or greater and 30 mm or less. Part of the display portion 922 can display an image while being bent since pixels are continuously arranged from the housing 921a to the housing 921b.

Since the hinge 923 includes the above-described locking mechanism, excessive force is not applied to the display portion 922; thus, breakage of the display portion 922 can be prevented. Consequently, a highly reliable electronic device can be obtained.

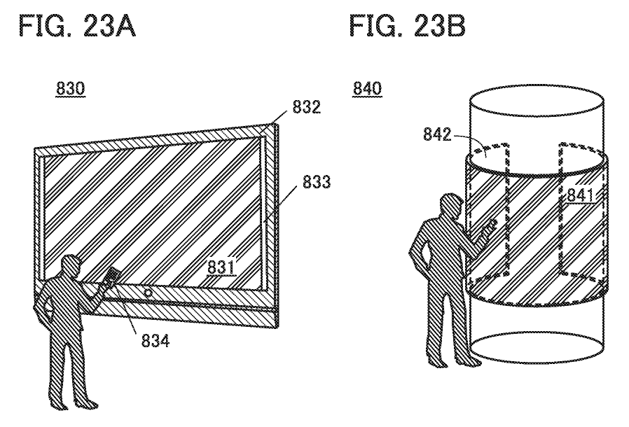

FIG. 23A illustrates a monitor 830. The monitor 830 includes a display portion 831, a housing 832, a speaker 833, and the like. Also, the monitor 830 can each include an LED lamp, operation keys (including a power switch or an operation switch), a connection terminal, a variety of sensors, a microphone, and the like.

The photosensor described in the above embodiment is provided in the display portion 831 of the monitor 830. The monitor 830 can be controlled with a remote controller 834.

The monitor 830 can receive airwaves and function as a television device.

The monitor 830 can receive airwaves such as a ground wave and a wave transmitted from a satellite, airwaves for analog broadcasting, digital broadcasting, and the like, and image-sound-only broadcasting, sound-only broadcasting, and the like. For example, the monitor 830 can receive airwaves transmitted in a certain frequency band, such as a UHF band (about 300 MHz to 3 GHz) or a VHF band (30 MHz to 300 MHz). When a plurality of pieces of data received in a plurality of frequency bands is used, the transfer rate can be increased and more information can thus be obtained. Accordingly, the display portion 831 can display an image with a resolution higher than the full high definition, such as 4K2K, 8K4K, 16K8K, or more.

An image to be displayed on the display portion 831 may be generated using broadcasting data transmitted with technology for transmitting data through a computer network such as the Internet, a local area network (LAN), or Wireless Fidelity (Wi-Fi: registered trademark). In that case, the monitor 830 does not necessarily include a tuner.

The monitor 830 is connected to a computer and can be used as a computer monitor. Since many people can see the monitor 830 connected to a computer at the same time, and thus can be used for a conference system. In addition, the monitor 830 can display information from the computer through a network and can be directly connected to the network to be used for a television conference system.

The monitor 830 can also be used as a digital signage as described below with reference to FIG. 23B.

FIG. 23B illustrates a digital signage 840 mounted on a cylindrical pillar 842. The digital signage 840 includes a display portion 841.

The larger display portion 841 can provide more information at a time. In addition, a larger display portion 841 attracts more attention, so that the effectiveness of the advertisement can be expected to be increased, for example.

The photosensor described in the above embodiment is provided in the display portion 841. It is preferable because a device with such a structure does not just display a still or moving image, but can be operated by users intuitively. In the case where the display device of one embodiment of the present invention is used for providing information such as route information or traffic information, usability can be enhanced by intuitive operation.

This application is based on Japanese Patent Application serial no. 2017-010094 filed with Japan Patent Office on Jan. 24, 2017, the entire contents of which are hereby incorporated by reference.

1. An input unit for an information terminal comprising:
a support;
a movable portion provided on the support;
a laser device provided on the support with the movable portion provided therebetween; and
a switch connected to the laser device,
wherein the movable portion for adjusting the output direction of a laser light is provided so that the output direction of the laser light from the laser device coincides with a user's line of sight.

2. The input unit according to claim 1, wherein the support is glasses, a hat, a helmet, or a headgear.

3. The input unit according to claim 1, wherein the switch is a breath switch, a push-button switch, a pedal switch, or a blink switch.

4. The input unit according to claim 1,
wherein the laser device outputs a first laser light and a second laser light, and
wherein the first laser light and the second laser light are switched by the switch.

5. The input unit according to claim 1,
wherein the support is glasses, a hat, a helmet, or a headgear, and
wherein the switch is a breath switch, a push-button switch, a pedal switch, or a blink switch.

6. The input unit according to claim 1,
wherein the support is glasses, a hat, a helmet, or a headgear,
wherein the laser device outputs a first laser light and a second laser light, and
wherein the first laser light and the second laser light are switched by the switch.

7. The input unit according to claim 1,
wherein the switch is a breath switch, a push-button switch, a pedal switch, or a blink switch,
wherein the laser device outputs a first laser light and a second laser light, and
wherein the first laser light and the second laser light are switched by the switch.

8. The input unit according to claim 1,
wherein the support is glasses, a hat, a helmet, or a headgear,
wherein the switch is a breath switch, a push-button switch, a pedal switch, or a blink switch,
wherein the laser device outputs a first laser light and a second laser light, and
wherein the first laser light and the second laser light are switched by the switch.

9. An input method for an information terminal comprising an input unit for performing input to the information terminal,
wherein the input unit includes a laser device and a switch connected to the laser device,
wherein the information terminal includes a display portion,
wherein the display portion includes a sensor,
wherein a region in the display portion is irradiated with a first laser light output from the laser device,
wherein the first laser light is switched from the first laser light to a second laser light,
wherein the region is irradiated with the second laser light,
wherein the sensor included in the region detects the second laser light, and
wherein the first laser light is switched to the second laser light with the switch.

10. The input method according to claim 9, wherein the second laser light and the first laser light have different intensities.

11. The input method according to claim 9, wherein the second laser light has a higher intensity than the first laser light.

12. The input method according to claim 9, wherein each of the first laser light and the second laser light is a pulsed laser light.

13. The input method according to claim 12, wherein the second laser light has a shorter pulse period than the first laser light.

14. The input method according to claim 12, wherein the second laser light and the first laser light have different duty ratios.

15. The input method according to claim 9,
wherein the second laser light and the first laser light have different intensities, and
wherein the second laser light has a higher intensity than the first laser light.

16. An input support system for an information terminal including an input unit for performing input to the information terminal, and artificial intelligence,
wherein the input unit includes a laser device and a switch connected to the laser device,
wherein the information terminal includes a display portion,
wherein the display portion includes a sensor,
wherein a region in the display portion is irradiated with a first laser light output from the laser device,
wherein the sensor detects the first laser light,
wherein information is input to the information terminal with the switch, and
wherein the artificial intelligence extracts and holds a movement pattern of the first laser light detected by the sensor.
